(19) United States
(12) Patent Application Publication
(10) Pub. No.: US 2025/0154324 A1
(43) Pub. Date: May 15, 2025

(54) POLYORGANOSILOXANE COPOLYMERS WITH ORGANIC POLYMERS

(71) Applicant: WACKER CHEMIE AG, Munich (DE)

(72) Inventor: Frank Sandmeyer, Burgkirchen (DE)

(73) Assignee: WACKER CHEMIE AG, Munich (DE)

(21) Appl. No.: 18/841,105

(22) PCT Filed: Feb. 25, 2022
(86) PCT No.: PCT/EP2022/054894

§ 371 Date: Aug. 23, 2024

(51) Int. Cl. C08G 77/46; C08G 65/48; C08G 77/20

(52) U.S. Cl. CPC C08G 77/46; C08G 65/485; C08G 77/20; C08G 2150/00

(57) ABSTRACT

A polyarylene ether-polysiloxane copolymer along with processes for preparing and uses for the same. Where the polyarylene ether-polysiloxane copolymer contains olefinically unsaturated groups, of the formula (I)

[O_{3-a/2}RₐSi—Y¹(SiRₐO_{3-a/2})_{b}]_{c}(R¹SiO_{3/2})_{d}(R²₂SiO_{2/2})ₑ(R³₃SiO_{1/2})_{f}(SiO_{4/2})_{g} (I).
Where the polyarylene ether radical is selected from a radical of the formula (II) or (III)

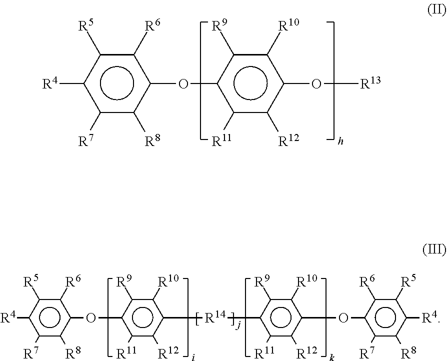

The invention relates to hydrolysis-stable, curable copolymers of three-dimensionally crosslinked polyorganosiloxanes with polyarylene ethers, to the production thereof, and to the use thereof for the production of components for high-frequency applications.

With advancing exploitation of high-frequency technology for wireless communication, there is an increasing need for materials suitable for implementation thereof. This relates to all fields of materials such as copper foils, binders, glass fibers, etc. In the case of the binders, the epoxy resins that were used conventionally for the production of both flexible and rigid metal foil-clad, especially copper foil-clad, laminates or consequently for printed circuit board production are no longer usable owing to excessively high dielectric loss factors. Polytetrafluoroethylene, which has a very low dielectric loss factor and has good usability from that point of view for high-frequency applications, has other disadvantages, especially poor processibility and poor bonding properties, which mean that an alternative is desirable. Polyarylene ethers are currently being utilized intensively as binders for this field of application, since they combine low dielectric loss factors with good mechanical and thermal properties and water repulsion.

In addition, other organic polymers are also being considered in current development work for this field of application, for example bismaleimide polymers, bismaleimide-triazine copolymers and hydrocarbon resins, among others that could also be added to this enumeration.

Polyorganosiloxanes fundamentally have excellent heat resistance, weathering stability and hydrophobicity, are flame-retardant, and have low dielectric loss factors.

These profiles of properties qualify both the organic polymers mentioned and the polyorganosiloxanes for use as binders for the production of high-frequency copper foil-clad laminates and components such as printed circuit boards and antennas. It is therefore obvious to combine the positive properties of these material classes, in the present case of the polyarylene ethers in particular, in order to symbiotically increase their performance. Corresponding attempts are already described in the prior art.

A significant challenge here is to combine the polysiloxanes and the polyarylene ethers with one another in such a way that they are mutually compatible and do not separate. Physical mixtures frequently do not meet this prerequisite. In particular, only highly aromatically substituted polysiloxanes are suitable for such a mixing approach. Since aliphatic substituents frequently result in better dielectric properties and small aliphatic silicon-bonded radicals in particular, such as the methyl radical, cause particularly low material shrinkage in the event of fire, or a particularly high proportion by mass remains as combustion residue from the corresponding polysiloxanes, a method that permits combination of any desired polysiloxanes with polyarylene ethers has clear benefits. Such a method consists in the copolymerization of polysiloxanes with polyarylene ethers. There is already prior art in this regard.

### PRIOR ART

U.S. Pat. No. 5,357,022 teaches flame-retardant thermoplastic polyorganosiloxane-polyarylene ether block copolymers formed from polydiorganosiloxane macromonomers that each have two terminal 2-methoxy-4-trimethylenephenol groups and 2,6-xylenol, obtained by oxidative coupling. It is shown that polydiorganosiloxanes of different chain length are usable in order to obtain the inventive effect of flame retardancy. The hydroxyaryl-terminated polydiorganosiloxanes used in accordance with the invention for copolymer synthesis are obtained by hydrosilylation of an allyl-functional phenol, for example eugenol, with an Si—H-terminal polydiorganosiloxane.

U.S. Pat. No. 8,017,697 demonstrates that the yield of polyarylene ether-polydiorganosiloxane block copolymers by the process according to U.S. Pat. No. 5,357,022 is quite low, which means that predominantly physical mixtures of polyarylene ether and the silicone component used are formed, which are in some cases only of limited miscibility, and the inventive effect of flame retardancy according to U.S. Pat. No. 5,357,022 has considerable potential for improvement, the realization of which is the teaching of U.S. Pat. No. 8,017,697.

Neither the copolymers according to U.S. Pat. No. 5,357,022 nor those according to U.S. Pat. No. 8,017,697 had free-radically crosslinkable, olefinically unsaturated groups for chemical curing. All that remain for further chemical reaction are the phenol group of the terminal 2,6-xylenol units.

Conventional methods of crosslinking and curing such polyarylene ethers are processes with addition of an excess of a thermally curing resin such as an epoxy resin or a crosslinking compound such as triallyl isocyanurate, although the property of a low dielectric loss factor, a low dielectric constant and high heat resistance, which is intrinsic to polyarylene ethers, is not achievable by these processes. For example, polyarylene ether/polyepoxide compositions are disclosed in JP 6-206984 A and JP 11-302529 A. Because these processes bring about crosslinking and curing by the addition of an excess of polyepoxide to polyarylene ethers, the property of low dielectric loss factor, low dielectric constant and high heat resistance, which are intrinsic to polyarylene ethers, cannot be achieved. JP 11-236430 A discloses a composition consisting of polyarylene ether, a brominated epoxy compound and an allyl compound, but the problem here is that the property of the low dielectric loss factor, a low dielectric constant and a high heat resistance which is intrinsic to polyarylene ethers is worsened because of the high proportion of the epoxy compound and of the allyl compound in the composition.

The polydiorganosiloxane-polyarylene ether copolymers according to U.S. Pat. No. 5,357,022 are therefore unsuitable for use in high-frequency applications because of their curing characteristics. Moreover, polydiorganosiloxanes themselves are soft structural elements that exert a softening effect on the copolymer and reduce the glass transition temperature thereof. This causes a reduction in glass transition temperature, which means a processing disadvantage for a binder for electronic components, for example copper foil-clad laminates for printed circuit board production. This is because binders having a low softening temperature tend to flow under the conditions of soldering and would leave holes in the electronic component. This makes the printed circuit boards unusable.

US20180155547 teachers thermoplastic formulations composed of polyarylene ethers, polyarylene ether-polysiloxane block copolymers, homopolystyrene, a flame retardant and a reinforcing filler. The formulations of the invention, according to US 20180155547, have a balance between the properties of flame retardancy, heat resistance, stiffness and melt flow characteristics. The polyarylene ether-polysiloxane block copolymers are constructed similarly to those from U.S. Pat. Nos. 5,357,022 and 8,017,697, although US20180155547, analogously to U.S. Pat. No. 8,017,697, permits not only C₁-C₁₂ hydrocarbyl radicals and C₁-C₁₂ halohydrocarbyl radicals but also silicon-bonded hydrogen on the polysiloxane chains of the structure

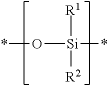

Similarly to U.S. Pat. No. 5,357,022, the blocks here are also linear polysiloxane blocks and hence essentially optionally water-substituted polydiorganosiloxanes. The polyorganosiloxane units used for synthesis are hydroxyaryl-terminated here too, in order that they are capable of oxidative coupling with further phenol units. By contrast with U.S. Pat. No. 5,357,022, US 201801555047 also permits hydroxyaryl-terminated radicals in the polysiloxane chain, and not just at the end. Thus, according to US 20180155547, not only are linear block copolymers possible as in U.S. Pat. No. 5,357,022, but also branched block copolymer structures that arise as a result of growth of polyarylene chains not just on the terminal hydroxyaryl radicals but also on the catenated hydroxyaryl radicals as a result of oxidative coupling.

The polyorganosiloxanes according to US 201801555047 again do not contain any organofunctional groups that would permit further chemical curing, especially no olefinic groups that permit free-radical curing. Because of the considerable analogies of the polyorganosiloxane structures according to US 20180155547 and U.S. Pat. No. 5,357,022, it can be assumed in an obvious manner that the hydroxyaryl-functional polyorganosiloxanes for production of the polyarylene ether-polysiloxane block copolymers according to US 20180155547 are likewise produced by hydrosilylation from allyl-functional phenols and Si—H-functional polydiorganosiloxanes, especially since the same inventor explicitly states this in U.S. Pat. No. 8,017,697 and the structures specified therein, which correspond to those in US 20180155547. This is additionally also obvious since US 20180155547 also permits Si—H groups in the polyorganosiloxane chains and catenated hydroxyaryl radicals. If there are catenated Si—H groups in the polydiorganosiloxanes, these will partly be involved in this hydrosilylation reaction and hence lead to the catenated hydroxyaryl radicals that are the cause of the branches allowed in accordance with the invention by virtue of laterally grown polyphenylene ether chains in the polyarylene ether polysiloxane block copolymers. Branches in the polyorganosiloxane unit by what are called T units of the general form RSiO_{3/2} or Q units of the form SiO_{4/2} are not present in the block copolymers, but rather solely the siloxane units, commonly referred to as D units, of the above-specified siloxane units that are described in generalized form as R₂SiO_{2/2}.

The polyarylene ether-polysiloxane block copolymers according to US 2018015547, like the polyarylene ether-polysiloxane block copolymers according to U.S. Pat. Nos. 5,357,022 and 8,017,697 already as well, have no further functional groups capable of chemical curing, in particular free-radical curing, except for the phenolic OH end groups, which is associated with the same disadvantages with regard to dielectric properties as already described further up.

U.S. Pat. No. 8,309,655 describes the synthesis of polyarylene ether-polysiloxane block copolymers that are obtained not by the oxidative coupling of hydroxyaryl-functional polysiloxanes and phenols, but by the reaction of alpha,omega-hydroxy-terminated polyarylene ethers with alpha,omega-hydroxyaryl-terminated polyorganosiloxanes and aromatic dicarbonyl chlorides.

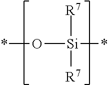

The hydroxyaryl-terminated polyorganosiloxanes used have the structure below, where R⁷ may be not only C₁-C₁₂ hydrocarbyl radicals and C₁-C₁₂ halohydrocarbyl radicals but also silicon-bonded hydrogen. In this case, the formation reaction specified for the hydroxyaryl-terminated polysiloxanes is a hydrosilylation reaction.

A problem in the reaction of the alpha,omega-hydroxy-terminated polyarylene ethers with alpha,omega-hydroxyaryl-terminated polyorganosiloxanes and aromatic dicarbonyl chlorides is the control of the reaction. The alpha,omega-hydroxy-terminated polyarylene ethers and the alpha,omega-hydroxyaryl-terminated polyorganosiloxanes have different reactivity compared to the aromatic dicarbonyl chlorides, such that the composition of the copolymer can be controlled only with a certain lack of sharpness and elevated complexity compared to the oxidative coupling method.

In this case too, the block copolymers contain only the remaining phenolic OH groups as functional groups, and no further organofunctional, especially free-radically curable, olefinically unsaturated groups, with the consequences and disadvantages for electronic high-frequency applications that have already been described above.

There are indeed several examples of such alternatives to the oxidative coupling reaction as formation reaction for polyarylene ether-polysiloxane copolymers. For example, JP61252214 describes the production of polyarylene ether-polysiloxane copolymers by the reaction of lithiated polyparylene ethers with single-sidedly chloride-functional siloxane macromonomers. U.S. Pat. No. 4,814,392 describes the formation of polyarylene ether-polysiloxane copolymers by the reaction of anhydride-functional polyarylene ethers with amino-terminated polysiloxanes. US 20070208144 describes the synthesis of polyarylene ether-polysiloxane copolymers by the reaction of polyarylene ethers with hydroxyaryl-terminated polysiloxanes in the presence of activated aromatic carbonates. All these synthetic methods have their specific disadvantages. Some of them require many reaction steps and the use of chemicals that are costly and of limited availability, the handling of which would cause considerable problems on an industrial scale and would incur additional complexity and costs. Alternatives to oxidative coupling as the process of choice for production of polyarylene ethers and derivatives or variants thereof have therefore not become established. Apart from that, exclusively linear polysiloxane structures are used in these documents and teachings, i.e. polydiorganosiloxanes having terminal functional groups. No crosslinked siloxane structures are obtained, nor is there any description of additional functional groups, especially olefinically unsaturated functional groups suitable for free-radical curing.

### OBJECT OF THE INVENTION

It is an object of the invention to provide hydrolysis-stable copolymers, which are chemically curable to thermosets, of three-dimensionally crosslinked polyorganosiloxanes with polyarylene ethers, and a process for the production thereof and a teaching for the use thereof for the production of components for high-frequency applications.

The Invention provides polyarylene ether-polysiloxane copolymers containing olefinically unsaturated groups, of the formula (I)

[O_{3-a/2}RₐSi—Y¹(SiRₐO_{3/2})_{b}]_{c}(R¹SiO_{3/2})_{d}(R²₂SiO²₂)ₑ(R³₃SiO_{1/2})_{f}(SiO_{4/2})_{g} (I),
where
Y¹ is a chemical bond or a di- to dodecavalent organic unsubstituted or heteroatom-substituted aliphatic, cycloaliphatic or aromatic, organic radical bonded to the silicon atoms via a Si—C bond and having 1 to 24 carbon atoms,
R, R¹, R² and R³ are independently the same or different and are either a hydrogen radical, a hydroxy radical or a Si—C-bonded or Si—O-bonded, monovalent, unsubstituted or heteroatom-substituted and optionally organofunctional organic hydrocarbyl radical having 1 to 18 carbon atoms or a Si—C-bonded polyarylene ether radical,
where the proportion of the hydroxyl radicals and of the Si—O-bonded radicals based on the sum total of all R, R¹, R² and R³ radicals as 100 percent by weight is not more than 5 percent by weight,
where the proportion of the Si—C-bonded polyarylene ether radicals based on the sum total of all R, R¹, R² and R³ radicals as 100 percent by weight is at least 10 percent by weight,
where the proportion of the olefinically or acetylenically unsaturated radicals based on all R, R¹, R² and R³ radicals as 100 moil is at least 0.5 mol %,
where the polyarylene ether radical is selected from a radical of the formula (II) or (III)

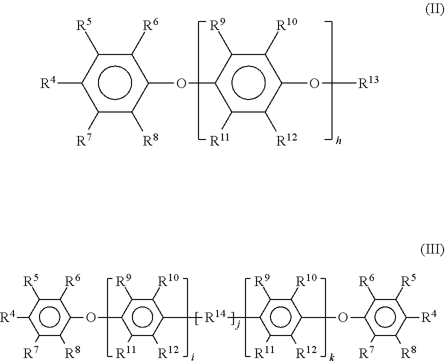

where the R⁴, R⁵, R⁶, R⁷, R⁸, R⁹, R¹⁰, R¹¹, R¹² and R¹³ radicals are independently a hydrogen radical, a monovalent hydrocarbyl group, a heteroatom-substituted hydrocarbyl group, an organofunctional radical or a silyl group of the (R⁴⁰₃Si—) form where R⁴⁰ has the definitions of R³ and the R⁴ to R¹² radicals may also be bonded to the aromatic ring via a heteroatom, where the R⁴, R⁵ and R⁶ radicals may also be a chemical bond or a divalent aliphatic, cycloaliphatic or aromatic hydrocarbyl radical having 1 to 12 carbon atoms, by which the bond of the radicals of the formula (II) to the polyorganosiloxane skeleton is established, where at least one R⁴, R⁵ or R⁶ radical is a radical that establishes a bond to the polyorganosiloxane skeleton,
where, as far as chemically possible, adjacent radicals from the group of the R⁴ to R¹² radicals may also be joined to one another to form the same cyclic saturated or unsaturated radical, so as to form fused polycyclic structures that include both cycloaliphatic and cycloaromatic structures or mixed forms thereof,
where the R¹⁴ radical is a chemical bond or a divalent, optionally substituted arylene radical of the (—C₆R¹⁵₄—) form where R¹⁵, independently of these, may have the same meaning as the R⁹, R¹⁰, R¹¹ or R¹² radicals or is an alkylene radical of the —CR¹⁶₂— form where R¹⁶, independently of R¹⁵, may have the same meanings as R¹⁵, a divalent glycol radical of the —[(OCH₂)₂O]ₗ— or —[(OCH₂CH(CH₃)₂)O]ₘ— form where l and m are each independently integers each having a value from 1 to 50 inclusive, a divalent silyloxy radical of the —Si(R¹⁷)₂O_{2/2}— form, a divalent siloxane radical of the —[(CH₂)₃Si—[O—Si(R¹⁸)₂]ₙO—Si(CH₂)₃— form, a divalent silyl radical of the —Si(R¹⁹)₂— form, where R¹⁷, R¹⁸ and R¹⁹, independently of one another and independently of R¹⁵, may have the same meanings as R¹⁵ and n is an integer having a value in each case of 0 to 500 inclusive,
where a is an integer having a value of 0, 1 or 2, where the indices a on either side of the Y group may assume their meaning independently of one another, such that different a may independently have different values within the range of values specified,
h has a value from 0 to 1000,
b is an integer having a value from 1 to 11.
c has a value from 0 to 0.9,
d has a value from 0 to 1,
e has a value from 0 to 0.5
f has a value from 0 to 0.6 and
g has a value from 0 to 0.2,
where c+d+e+f+g=1 and at least c or d has a value other than 0 and the sum of c+d accounts for a proportion of at least 40% of the sum of c+d+e+f+g,
i is an integer having a value of in each case 0 to 50 inclusive,
j is an integer having a value of in each case 0 to 10 inclusive, and
k is an integer having a value of in each case 0 to 50 inclusive,
with the proviso that at least one polyarylene ether radical of the formula (II) or (III) is present in each polyarylene ether-polysiloxane copolymer of the formula (I).

The polyarylene ether-polysiloxane copolymers of the formula (I) are copolymers, chemically curable to thermosets by means of olefinically unsaturated groups, of three-dimensionally crosslinked polyorganosiloxanes with polyarylene ethers. They overcome and improve on the disadvantages that have been recognized in the prior art, since it is possible to dispense with the addition of auxiliary polymers or other substances for curing that adversely affect dielectric properties, i.e. increase the dielectric loss factor and the dielectric constant, and the curing of the polyarylene ether-polyorganosiloxane copolymers of the invention as sole binder affords ready-to-use materials suitable for use in high-frequency applications.

If there are two or more polyarylene ether radicals per polyarylene ether-polysiloxane copolymer of the formula (I), these may be either solely those of the formula (II) or solely those of the formula (III) or mixtures of those of the formula (II) and of the formula (III).

The arrangement of the structural groups may be random or blockwise. This means that structural groups [O_{3-a/2}RₐSi—Y¹(SiRₐO_{3-a/2})_{b}]_{c}, (R¹SiO_{3/2})_{d}, (R²₂SiO_{2/2})ₑ, (R³₃SiO_{1/2})_{f} and (SiO_{4/2})_{g} alternate randomly with one another in the molecular structure, or there are blocks composed of multiple repeat units of the same form in each case, i.e. of [O_{3-a/2}RₐSi—Y¹(SiRₐO_{3-a/2})_{b}]_{c} or (R¹SiO_{3/2})_{d} or (R²₂SiO_{2/2})ₑ or (R³₃SiO_{1/2})_{f} or (SiO_{4/2})_{g}, as well as blocks composed of multiple repeat units of the respective other structural groups, where at least 3 identical structural groups in each case must be combined to form a block in order to obtain an effective block structure.

Preferably, in each case independently, the value of d is at least 4, c+f is at least 9, preferably at least 15, especially 20 to 100, and g is at least 1.

Preferably, the proportion of the hydroxyl radicals and of the Si—O-bonded radicals based on the sum total of all R, R¹, R² and R³ radicals as 100 percent by weight is not more than 4 percent by weight, more preferably not more than 3 percent by weight, especially not more than 2 percent by weight.

Preferably, the proportion of the Si—C-bonded polyarylene ether radicals based on the sum total of all R, R¹, R² and R³ radicals as 100 percent by weight is at least 12 percent by weight, more preferably at least 14 percent by weight, especially at least 15 percent by weight. It has been found to particularly useful to adjust the proportion of polyarylene ether radicals to at least 30 percent by weight, since this achieves particularly good bonding properties of the inventive polyorganosiloxane-polyarylene ether copolymers of the formula (I) in the inventive use as binders for high-frequency-capable metal laminates.

Preferably, based on all R, R¹, R² and R³ radicals as 100 mol %, at least 2 mol %, more preferably at least 3 mol % and especially at least 4 mol % are olefinically or acetylenically unsaturated radicals.

A preferred divalent hydrocarbyl radical selected from R⁴, R⁵ and R⁶ is the —(CH₂)₃— radical.

The polyarylene ether radicals of the formula (III) may be bonded either to just one end or to both ends of the polyorganosiloxane skeleton of the polyorganosiloxane-polyarylene ether copolymers of the formula (I).

Preferred R¹⁴ radicals are the chemical bond, the —CH₂— radical, the C(CH₃)₂— radical, the —C(C₆H₅)₂— radical and the —[(CH₂)₃Si—[O—Si(R¹⁸)₂]O—Si(CH₂)₃— radical.

Preferred values of h are 1 to 500, more preferably from 1 to 300 and especially preferably from 1 to 150.

A preferred value of b is 1.

Preferred values of e are 0 to 0.2.

Preferred values of f are 0 to 0.5.

Preferred values of g are <0.2.

Preferably, the sum total of c+d in the sum total of c+d+e+f+g is a proportion of at least 50%.

Preferably, i has values of 1 to 40, more preferably of 1 to 30 and especially preferably of 1 to 25.

Preferably, j has values of 0 to 5.

Preferably, k has values between 1 and 40, more preferably between 1 and 30 and especially preferably between 1 and 25.

As pure substances, the inventive polyorganosiloxane-polyarylene ether copolymers of the formula (I) preferably have average molecular weights Mw in the range from 500 to 750 000 g/mol, preferably from 600 to 600 000 g/mol, more preferably from 800 to 500 000 g/mol, especially from 800 to 40 000 g/mol, where the polydispersity is at most 50, preferably at most 45, more preferably at most 40, especially at most 35. The inventive polyorganosiloxane-polyarylene ether copolymers of the formula (I) are solid or liquid at 25° C. with viscosities at 25° C. of 20 to 8 000 000 mPas, preferably of 20 to 5 000 000 mPas, especially of 20 to 3 000 000 mPas, where the solid polyorganosiloxanes containing phenyl groups have glass transition temperatures in the uncrosslinked state in the range from 25° C. to 350° C., preferably from 30° C. to 300° C., especially from 30° C. to 280° C. Particularly suitable polyorganosiloxane-polyarylene ether copolymers of the formula (I) have been found to be those that are solid at 25° C. and have a glass transition temperature of 30-280° C.

The inventive polyorganosiloxane-polyarylene ether copolymers of the formula (I) are soluble in aromatic solvents in a proportion of at least 30% by weight of the solution. In other words, at least 30 parts of inventive polyorganosiloxane-polyarylene ether copolymers of the formula (I) are soluble in a solution composed of 100 parts in total consisting of solvent and inventive polyorganosiloxane-polyarylene ether copolymers of the formula (I). Examples of suitable solvents are aromatic solvents such as toluene, xylene, ethylbenzene or mixtures thereof. Solubility in other solvents fluctuates depending on the solvent chosen and the respective inventive polyorganosiloxane-polyarylene ether copolymer of the formula (I) and can vary from insoluble to good solubility.

Selected examples of preferred alkyl, cycloalkyl and aryl and alkaryl radicals R, R¹, R², R³ are the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical, cyclopentyl, cyclohexyl, cycloheptyl and methylcyclohexyl radicals, the phenyl, naphthyl, anthryl and phenanthryl radical, tolyl radicals, xylyl radicals and ethylphenyl radicals, and aralkyl radicals, such as the benzyl radical, the α- and the β-phenylethyl radical.

The unsubstituted radicals R, R¹, R², R³ are predominantly hydrocarbyl radicals having 1 to 12 carbon atoms, more preferably the methyl, ethyl and n-propyl radical and phenyl radical, especially the methyl, n-propyl and phenyl radical. Particular preference is given to the methyl radical and the phenyl radical.

Preferred heteroatoms that may be present in the R, R¹, R² and R³ radicals are oxygen atoms.

Also preferred in addition are nitrogen atoms, phosphorus atoms, sulfur atoms and halogen atoms such as chlorine atoms and fluorine atoms.

Examples of preferred heteroatom-substituted radicals R, R¹, R², R³ are glycol radicals such as polypropylene glycol radicals and polyethylene glycol radicals.

Selected examples of preferred organofunctional radicals R, R¹, R², R³ are acrylate and methacrylate radicals, such as methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate and norbornyl acrylate, particular preference being given to methyl acrylate, methyl methacrylate, n-butyl acrylate, isobutyl acrylate, t-butyl acrylate, 2-ethylhexyl acrylate, and norbornyl acrylate.

Further examples of R² radicals are olefinically or acetylenically unsaturated hydrocarbyl radicals of the formulae (IV) and (V)

Z—CR¹⁹═CR²⁰R²¹ (IV)

Z—C≡CR²² (V)
where Z is a chemical bond or a divalent linear or branched hydrocarbyl radical having up to 30 carbon atoms, where Z may also contain olefinically unsaturated groups or heteroatoms and the atom bonded directly to the silicon from the Z radical is a carbon. Heteroatom-containing fragments that may typically be present in the Z radical are —C—O—C—, —C(═O)—, —O—C(═O)—, —O—C(═O)—O—, where unsymmetric radicals may be incorporated into the Z radical in either possible direction, where R¹⁹, R²⁰, R²¹ and R²² are a hydrogen atom or a C1-C8 hydrocarbyl radical which may optionally contain heteroatoms, preference being given to heteroatom-free hydrocarbyl radicals, and where the hydrogen atom is the most preferred radical for R¹⁹, R²⁰, R²¹ and R²². Particularly preferred radicals (IV) are the vinyl radical, the allyl radical, the propenyl radical and the butenyl radical, especially the vinyl radical. The radical (IV) may also be a dienyl radical bonded via a spacer, such as the 1,3-butadienyl or the isoprenyl radical bonded via a spacer.

Further examples of R, R¹, R², R³ radicals are hydridic silicon-bonded hydrogen.

The R, R¹, R², R³ radicals, apart from the hydrogen atom which is always silicon-bonded, are generally not bonded directly to the silicon atom. An exception from this is formed by the olefinic or acetylenic groups that may also be present in directly silicon-bonded form, in particular the vinyl group. The other functional groups R, R¹, R², R³ are bonded to the silicon atom via spacer groups, where the spacer is always Si—C-bonded. The spacer here is a divalent hydrocarbyl radical which comprises 1 to 30 carbon atoms and in which nonadjacent carbon atoms may be replaced by oxygen atoms, and which may also contain other heteroatoms or heteroatom groups, though this is not preferred.

The methacrylate group and the acrylate group are preferably bonded via a spacer, where the spacer composed of 3 to 15 carbon atoms, preferably in particular 3 to 8 carbon atoms, in particular 3 carbon atoms, and optionally additionally not more than one divalent hydrocarbyl radical comprising up to 3 oxygen atoms, preferably not more than one 1 oxygen atom, is bonded to the silicon atom.

In principle, the term “olefinically unsaturated radicals” means all radicals containing at least one double bond, regardless of whether that double bond is part of a functional group otherwise referred to differently, for instance an acrylate group or a methacrylate group. In this context, an acetylenically unsaturated radical is one containing a triple bond. Radicals containing both double and triple bonds may be jointly comprehended by both terms and are likewise included.

If the Y¹ radical is not a chemical bond, it is always bonded exclusively by a Si—C bond to the silicon atoms that are bonded to one another by the Y¹ radical. Typical examples of bridging Y¹ radicals are connecting organic units having 1 to 24 carbon atoms between preferably two to twelve siloxanyl units. Preferably. Y¹ is di-, tri- or tetravalent, especially divalent. The Y¹ radical may also be a bridging organic radical containing a polyarylene ether radical of the formula (II) or (III).

Preferred bridging aromatic radicals Y¹ are those of the formula (VI)

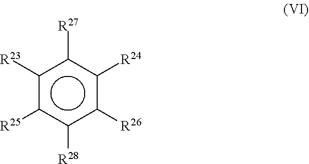

where the R²³, R²⁴, R²⁵, R²⁶, R²⁷ and R²⁸ radicals may be a hydrogen radical or an optionally substituted hydrocarbyl radical or a group of the formula OR²⁹ where R²⁹ is a hydrogen radical or a polyarylene ether radical of the formula (II) or (III) or an aliphatic or cycloaliphatic, optionally heteroatom-containing hydrocarbyl radical, where preferred heteroatoms are oxygen atoms. It is possible here for adjacent radicals in formula (VI) to be coupled to one another to form cyclic radicals, so as to give rise to fused ring systems. In particular, any two radicals from the group of R²³, R²⁴, R²⁵, R²⁶, R²⁷ and R²⁸ radicals are either a chemical bond or a divalent organic hydrocarbyl radical having 1 to 12 carbon atoms, preferably an aliphatic radical of the —(CH₂)₃— form having three carbon atoms that connects a silicon atom to the aromatic ring.

Typical examples of such bridging aromatic radicals are the p-, m- or o-phenylene radical, the 2-methyl-1,4-phenylene radical, the 2-methoxy-1,4-phenylene radical, particular preference being given to the p-phenylene radical.

It is optionally also possible to couple two or more radicals of this kind to one another, such that, for example, there are two or more units of the formula (VI) coupled to one another, and this oligomeric bridging structural unit is present through binding of the corresponding carbon atoms of the terminal aromatic rings to silicon atoms. The aromatic units may be bonded directly to one another or they may be coupled to one another by a bridging group such as an alkanediyl unit, for example the methylene group, the 1,2-ethanediyl group, 1,1-ethanediyl group, the 2,2-dimethylpropyl group or a sulfone group.

Further examples of aromatic bridging units are those in which two substituted phenol rings are bridged via an alkanediyl unit or another unit.

Typical representatives are the following radicals that are substituted on the phenol oxygen or on the aromatic ring: 2,2-bis(4-hydroxyphenyl)propane radicals (substituted bisphenol A radicals), 2,2-bis(4-hydroxyphenyl)methane radicals (substituted bisphenol F radicals), bis(4-hydroxyphenyl)sulfone radicals (bisphenol S radicals), where either the phenol oxygen atoms or the aromatic rings of the base skeletons are typically substituted by radicals of the —(C₃H₆)— type, where the —(C₃H₆)-radicals are bonded to silicon atoms Si—C, giving rise to the bridge. Unsubstituted phenol groups in the bisphenol base skeletons in such bridging units may either be substituted by radicals of the formula (II) or (III) during the synthesis of the polyorganosiloxane-polyarylene ether copolymers of the invention, such that even the bridging Y¹ radicals do not just constitute a structural peculiarity of the polyorganosiloxane skeleton but can also contribute to the forming of copolymers of the invention, or the structural group containing them on its own is already sufficient to form inventive polyorganosiloxane-polyarylene ether copolymers of the formula (I) if it additionally contains the required minimum amount of crosslinkable unsaturated radicals.

Preferred Y¹ radicals not bridged by an aromatic unit are alkanediyl, alkenediyl and alkynediyl radicals which may optionally contain heteroatoms and which may contain aromatic groups as substituents, but these do not assume the function of or contribute to bridging in these radicals. Typical examples are the methylene radical, the methine radical, tetravalent carbon, the 1,1-ethanediyl and the 1,2-ethanediyl group, the 1,4-butanediyl and the 1,3-butanediyl group, the 1,5-pentanediyl, 1,6-hexanediyl, 1,7-heptanediyl, 1,8-octanediyl, 1,9-nonanediyl, 1,10-decanediyl, 1,11-undecanediyl and the 1,12-dodecanediyl group, the 1,2-diphenylethanediyl group, the 1,2-phenylethanediyl group, the 1,2-cyclohexylethanediyl group. If a linear bridging unit has more than one carbon atom and if it is permitted by the substitution pattern, each of these groups may also have a bridging effect by virtue of any other connectivity, i.e. the use of different chain atoms, aside from that resulting from alpha,omega connectivity, i.e. bridging by the respective first and last atoms of a linear unit. Moreover, typical examples are not just the linear representatives of the bridging hydrocarbons mentioned, but also the isomers thereof, which may in turn have a bridging effect through binding of different carbon atoms of the hydrocarbon structure to silicon atoms.

Examples of especially preferred radicals from the group of the nonaromatic heteroatom-free hydrocarbyl radicals are —CH₂CH₂—, —CH(CH₃)—, —CH═CH—, —C(═CH)— and —C≡C—.

Examples of typical fluorine-substituted bridging Y¹ radicals are the —C(CF₃)₂—, the —C(H)F—C(H)F— and the —C(F₂)—C(F₂)— radical.

Examples of typical heteroatom-containing bridging radicals are, for example, the ethyleneoxypropylene radical and the ethyleneoxybutylene radical. Also typical examples are double-sidedly —(CH₂)ₙ— or —CH₂—CH(R³⁰)—C(═O)O-terminated radicals where n is typically 3 to 8 and R³⁰ is a hydrogen atom or a methyl group, and glycol radicals or phenylene ether radicals bonded to the silicon atoms via that terminal group.

A further typical example of a Y¹ radical is the chemical bond that directly connects two silicon atoms to one another.

Typical examples of R⁴, R⁵, R⁶, R⁷, R⁸, R⁹, R¹⁰, R¹¹, R¹² and R¹³ radicals and R²³, R²⁴, R²⁵, R²⁶, R²⁷ and R²⁸ radicals are the hydrogen radical, saturated hydrocarbyl radicals such as the methyl, ethyl, n-propyl, isopropyl, the primary, secondary and tertiary butyl radical, the hydroxyethyl radical, aromatic radicals such as the phenylethyl radical, the phenyl radical, the benzyl radical, the methylphenyl radical, the dimethylphenyl radical, the ethylphenyl radical, heteroatom-containing radicals such as the hydroxymethyl radical, the carboxyethyl radical, the methoxycarbonylethyl radical and the cyanoethyl radical, and acrylate and methacrylate radicals such as methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate and norbornyl acrylate, olefinically or acetylenically unsaturated hydrocarbyl radicals.

It is optionally also possible to join adjacent radicals to one another to form the likewise cyclic saturated or unsaturated radical, such that fused polycyclic structures are formed. Reference has been made further up to the possibility that particular radicals from the group of the R⁴, R⁵, R⁶, R⁷, R⁸, R²³, R²⁴, R²⁵, R²⁶, R²⁷ and R²⁸ radicals may be a chemical bond or a divalent hydrocarbyl radical.

If the index h in formula (II) is 0 and R¹³ is a hydrogen radical, the radical of the formula (II) is a substituted or unsubstituted phenol radical. Typical examples of such phenol radicals of the formula (II) are the phenol radical, the ortho-, meta- or para-cresol radical, 2,6-, 2,5-, 2,4- or 3,5-dimethylphenol radical, 2-methyl-6-phenylphenol radical, 2,6-diphenylphenol radical, 2,6-diethylphenol radical, 2-methyl-6-ethylphenol radical, 2,3,5-, 2,3,6- or 2,4,6-trimethylphenol radical, 3-methyl-6-tert-butylphenol radical, thymol radical, 2-methyl-6-allylphenol radical and the 4-allyl-2-methoxyphenol (=eugenol) radical, which may be optionally substituted on the oxygen atom and which may be bonded to the polyorganosiloxane skeleton by direct bonding of an aromatic ring carbon atom or by a C3 spacer of the —(CH₂)₃— form.

All enumerations of examples of typical radicals should be understood to be illustrative, but in no way limiting.

The polyorganosiloxane-polyarylene copolymers of the formula (I) preferably serve as binders for production of metal-plated laminates. The polyorganosiloxane-polyarylene copolymers of the formula (I) are crosslinked in the production of laminates. The laminates are preferably metal foil-clad laminates. The laminates are preferably used in electronic components, preferably in high-frequency applications, very particularly those that are operated at frequencies of 1 GHz or higher.

It has been found that, surprisingly, polyorganosiloxane-polyarylene copolymers of the formula (I) bearing unsaturated organic functional groups that are suitable for the purpose or formulations thereof are particularly suitable.

The polyorganosiloxane-polyarylene copolymers of the formula (I) have a dielectric loss factor of not more than 0.0040 at 10 GHz.

The polyorganosiloxane-polyarylene copolymers of the formula (I), in the context of the present invention, especially also include the preferred structures of the formulae (Ia), (Ib), (Ic) and (Id)

[O_{3-a/2}RₐSi—Y¹(SiRₐO_{3-a/2})]_{c}(R³₃SiO_{1/2})_{f} (Ia)

[O_{3-a/2}RₐSi—Y¹(SiRₐO_{3-a/2})_{b}]_{c}(R¹SiO_{3/2})_{d}(R³₃SiO_{1/2}) (Ib)

(R¹SiO_{3/2})_{d}(R³₃SiO_{1/2})_{f} (Ic)

(R¹SiO_{3/2})_{d} (Id).

These are particularly suitable for execution of the invention. They do not contain any units of the formula (R²₂SiO_{2/2})ₑ, which, in the polyorganosiloxanes according to the prior art to date, are the main, if not the exclusive, constituents. This is a structurally particularly apparent delimiting feature of the present invention from the known prior art.

In a particularly preferred embodiment of (Ia) and (Ib), the value of a=2 and b=1. All definitions of the radicals and indices in the formulae (Ia), (Ib), (Ic) and (Id) are the same as already stated further up.

The inventive polyorganosiloxane-polyarylene ether copolymers of the formula (I) are preferably prepared from hydroxyaryl-functional polyorganosiloxane compounds of the formula (VII) by oxidatively coupling the arylhydroxy radicals of the polyorganosiloxane compounds of the formula (VII)

[O_{3-a/2}R³¹ₐSi—Y¹(SiR³¹ₐO_{3-a/2})_{b}]_{c}(R³²SiO_{3/2})_{d}(R³³₂SiO_{2/2})ₑ(R³⁴₃SiO_{1/2})_{f}(SiO_{4/2})_{g} (VII)
where
R^{3′} is an R radical, R³² is an R¹ radical, R³³ is an R² radical, R³⁴ is an R³ radical and Y² is a Y¹ radical, with the difference that, if R³¹, R³², R³³ or R³⁴ is a radical of the formula (II) or if Y² comprises such a radical of the formula (II), the index h in this radical of the formula (II) is always 0 and the R¹³ radical is always a hydrogen radical and that R³¹, R³², R³³ and R³⁴ cannot be a polyarylene ether radical of the formula (III), and that Y² cannot contain a radical of the formula (III),
with the proviso that at least 1 mol % of all Si-bonded radicals are a radical of the formula (II) with h=0 and R¹³=hydrogen,
with phenols of the formula (VIIIa) or (VIIIb) or a mixture of (VIIIa) and (VIIIb)

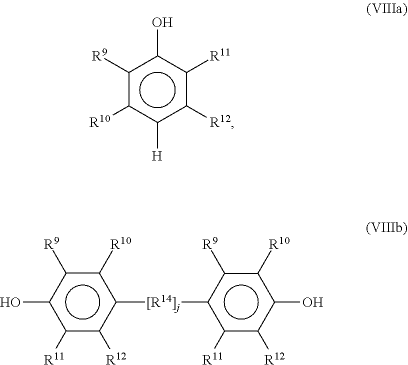

where the R⁹, R¹⁰, R¹¹, R¹² and R¹⁴ radicals and j have the definitions given above.

In the process, radicals of the formula (II) with h=0 and R¹³=hydrogen must be present in a sufficient amount in the polyorganosiloxanes of the formula (VII) that there are sufficient coreactants available for the phenols of the formula (VIII) to form the inventive copolymers of the formula (I). This is the case when at least one 1 mol %, preferably at least 2 mol %, of all Si-bonded radicals are a radical of the formula (II) with h=0 and R¹³=hydrogen. This is therefore an essential condition for the polyorganosiloxanes of the formula (VII).

The phenols for oxidative coupling with the polyorganosiloxanes of the formula (VII) are those of the formula (VIIIa) in order to create a radical of the formula (II).

The phenols for oxidative coupling with the polyorganosiloxanes of the formula (VII) are bisphenols of the formula (VIIIb) to create a radical of the formula (III).

j is preferably 0 or 1, especially 1.

According to the tolerance of the chosen preparation process for olefinically and acetylenically unsaturated groups, these groups that are essential to the invention are inserted in further process steps after the copolymerization. How this is possible, and what options are available in the selection of only limitedly hydrosilylatable olefinic and acetylenic groups in the production of the inventive copolymers of the formula (I), will be elucidated further down.

Oxidative coupling is known per se. The process of oxidative copolymerization of phenol compounds to prepare polyphenylene ethers is described by way of example in U.S. Pat. No. 3,306,874, although this pointer should be understood to mean merely illustrative and nonlimiting, meaning that any other prior art suitable for preparation of polyarylene ethers is likewise of relevance here. The further steps for subsequent functionalization are also already prior art as such. However, they are not described in combination, which means that the processes that are described here are novel overall. The fact that this novel combination of known processes solves a problem that was unsolved to date is surprising. If this had been obvious, the problem would have been successfully solved earlier on, since, as is shown in the discussion of the prior art, the creation of corresponding polymers for commercial purposes has already been a subject of research for more than 20 years.

The viscosity of the polyorganosiloxane compounds of the formula (VII), depending on the average number of the structural units that form them per molecule, may vary over a wide range, or else they may be solids.

Liquid organopolysiloxane compounds of the formula (VII) in the uncrosslinked state at 25° C. have viscosities of preferably 20 to 8 000 000 mPas, more preferably of 20 to 5 000 000 mPas, especially of 20 to 3 000 000 mPas.

Solid organopolysiloxane compounds of the formula (VII) in the uncrosslinked state have glass transition temperatures within the range from preferably 25° C. to 250° C., more preferably from 30° C. to 230° C., especially from 30° C. to 200° C.

The organopolysiloxane compounds of the formula (VII) may be prepared by any process. A preferred process for preparing these compounds is the hydrolysis and cocondensation of compounds of the general formula (IX)

Hal₃₋ₐR³¹ₐSi—Y²(SiR³¹ₐHal₃₋ₐ)_{b} (IX)
with compounds of the formula (X)

R¹⁶ₘSiHal₄₋ₘ (X)
where Hal is a hydrolyzable group,
R³¹ and Y² have the definitions already given above.
m is an integer in the range from 0 to 3,
where R³¹ when m=1 is an R¹ radical, when m=2 is an R² radical, and when m=3 is an R³ radical,
and a and b have the definitions already given for the formula (VII).

The compounds (IX) are obtained by prior art processes, where the reaction types to be employed depend greatly on the composition of the respective compound (IX). Typically, compounds (IX) are obtained, for example, by hydrosilylation from olefinically unsaturated organic precursors, for example acetylene, diallyl or divinyl compounds and Si—H-functional silicone units.

Grignard reactions from halogenated organic precursors and subsequent reaction with halogenated or alkoxylated organosilanes are also conceivable processes here. It is optionally also possible to employ metal halide exchange reactions of halogenated organic precursors with alkali metal alkyl compounds, for instance butyllithium, and known further reactions for linkage to silicone units. The person skilled in the art is aware of such methods, which are readily accessible and comprehensible front the available literature. Since these methods are not the subject of the invention, reference is merely made at this point to the documented and searchable prior art.

The relative ratios in which the compounds of the formula (IX) are cocondensed with the compounds of the formula (X) are defined by the values of the indices c, d, e, f and g in formula (VII).

Hal is preferably a halogen, acid or alkoxy group, more preferably a chlorine, acetate, formate, methoxy or ethoxy group.

The organosiloxanes thus obtained can optionally be altered and modified further by further reactions, for example equilibration, such that it is possible by employment of known methods according to the prior art to prepare virtually any branched siloxane oligomers and polymers and silicone resins, all of which are considered to be covered by the term “organopolysiloxanes” in the context of present invention.

The cohydrolysis is preferably performed in such a way that a mixture of compounds (IX) and (X), optionally together with a preferably aromatic solvent, is metered into water or dilute acids while cooling. In the case of gaseous acids such as HCl, metered addition into a concentrated aqueous HCl solution is likewise advisable if the acid released is to be recovered in gaseous form. Depending on the nature of the Hal group, the hydrolysis is more or less strongly exothermic, such that cooling is required both in the interests of safe execution of the reactions and possibly for avoidance of side reactions in corresponding synthesis sequences. For completion of the reactions, by contrast, it may be advantageous and necessary to employ elevated temperatures.

The reaction times are generally very short in the case of chlorosilanes, such that the time required for performance of the process in batchwise operation depends mainly on the cooling output. Alternatively, the cohydrolysis of (XI) and (XII) can also be conducted continuously, for which possible options are a loop, and also column reactors and tubular reactors. For depletion of residual acids, good washing with water, clean phase separation and purification of the hydrolysis product under reduced pressure are advantageous. The process can be conducted under standard pressure. Depending on the objective, however, higher or lower pressure is likewise practicable.

As a result of the use of the groups of the formula (R³₃SiO_{1/2})_{f}, it is necessarily possible during the synthesis both to control the molecular weight and to reduce the level of alkoxy and silanol groups. The latter are formed during the synthesis if the synthesis is conducted in a hydrolytic process, which is the preferred embodiment. If the groups of the formula (R³₃SiO_{1/2})_{f} are generated using a chlorosilane precursor, symmetric disiloxanes are also formed therefrom in the course of the synthesis, but these are cleavable again under the conditions of the acidic hydrolysis and are therefore still available as terminating groups for reactions with silanol groups, since starting materials are formed on the organopolysiloxane that forms after hydrolysis of the chlorosilanes. Thus, the silanol groups are reduced. Since alkoxy groups, especially those having small alkyl radicals, likewise form silanol groups under the conditions of the acidic hydrolysis with elimination of short-chain alcohols, the alkoxy groups are also reduced by the additional use of the terminating structural groups. It is also possible to use these in excess, since any remaining disiloxanes can generally be distilled off after the synthesis has ended, particularly when they are substituted exclusively or predominantly by short-chain alkyl radicals, in particular methyl radicals.

The chlorosilanes or disiloxanes that form these terminal groups can also be added to the synthesis separately in a final step, and the reduction of the silanol groups can be brought about in a controlled manner by acidic hydrolytic conditions. It is advantageous here to always use an excess of terminating chlorosilanes and to remove the disiloxanes formed by distillation. It is particularly advantageously possible for this purpose to use vinyldimethylchlorosilane, dimethylchlorosilane or trimethylchlorosilane, since the disiloxanes that are formed therefrom are removable particularly easily by distillation. Alternatively, it is of course also possible to use the disiloxanes straight away and to choose hydrolytic conditions, in which case it is necessary to add a sufficient amount of catalytic acid, preferably hydrochloric acid. Typically, in this case, between 50 and 1000 ppm of hydrochloric acid is used, based on the amount of siloxane in the reaction mixture.

Functional groups not tolerated by the reaction forming the polyorganosiloxanes (VII) may be introduced subsequently into the polyorganosiloxane structure, for example by hydrosilylation. For example, it is thus possible to introduce a 4-allyl-2-methoxyphenol (eugenol) function or a 2-allylphenol function as typical examples of the hydroxyaryl radicals that are obligatory in (VII).

Since it is a requirement on the copolymers of the invention that they are free-radically crosslinkable in use by suitable olefinically unsaturated groups, it is necessary especially in the case of use of a hydrosilylation reaction that consumes olefinic groups to ensure that there is a sufficient number of olefinically unsaturated groups in the copolymer of the formula (I). The simplest way of achieving this is by the adjustment of the stoichiometry between olefinically unsaturated groups and Si—H groups, meaning that an appropriate excess of olefinic groups is used. If just one type of olefinic groups is used, the olefinic groups that are easiest to access in steric terms will react first, and the olefinic groups that are more difficult to access will remain for later free-radical curing. This leads not only to random copolymers but possibly also to drawbacks in free-radical curing, for example lower reaction rate or less complete reaction. In order to compensate for this, it is possible, for example, to use two different kinds of olefinically unsaturated groups that are hydrosilylated at different rates, for example allyl groups or vinyl groups as examples of rapidly hydrosilylatable groups combined with acrylate groups or methacrylate groups as examples of less easily hydrosilylatable olefinically unsaturated groups. Thus, hydrosilylation will proceed mainly or exclusively on the more rapidly hydrosilylatable groups, and the less quickly hydrosilylatable groups will remain in greater numbers for the subsequent free-radical curing. This creates the possibility of influencing the molecular architecture and reaction rates.

In principle, the subsequent introduction of the hydrosilylatable or free-radically curable groups required for the copolymers of the formula (I) is possible by known methods of organic chemistry, either by functionalizations on the polyarylene ether moiety or on the polysiloxane moiety or on both of these constituents that form the copolymers of the formula (I). Thus, the hydrosilylatable groups in the polyarylene ether units can be introduced, for example, on their optionally terminal phenolic OH groups. Reference is made here generally to the chemistry of the phenols, and by way of example the introduction of allyl groups to form allyl phenyl ether groups, which can be converted to allylphenols by subsequent Claisen rearrangement. Since it is possible here to make use of publicly accessible knowledge, the synthesis routes to the raw materials used here are known to the person skilled in the art and will not be detailed further at this point. It should additionally be pointed out that structural groups that can be used for the polyarylene ether units may optionally also be natural substances, for example eugenol (4-allyl-2-methoxyphenol), in order to introduce suitable olefinically unsaturated groups into the polyarylene ether radicals.

As an example, reference is also made here to the introduction of an acrylate group, by the reaction of a phenolic OH group with 3-chloropropionyl chloride to give a 3-chloropropionic ester and the subsequent elimination of HCl from the chloropropyl radical by addition of trialkylamine, for example, to the reaction mixture, which forms the acrylate group by establishment of the double bond pointed out, since the acrylate group is a relevant free-radically curable group. This reaction sequence too is described in the literature and is therefore known to those skilled in the art.

As a further example, the introduction of olefinic groups by subsequent silylation with olefinically unsaturated chlorosilanes or olefinically unsaturated disiloxanes is elucidated further down as a further option.

A further way of ensuring that there is a sufficient number of olefinically unsaturated free-radically curable functional groups in the copolymer of formula (I) is to subsequently functionalize the copolymer, after oxidative coupling in the case of combination of formula (VII) with formula (VIIIa) and formula (VIIIb), by proceeding in the same manner as already described above for the control of the molecular weight of the polyorganosiloxanes (VII). This means that further groups of the formula (R³₃SiO_{1/2})_{f} where R³ may have the definitions given above are introduced into the initially obtained copolymers after the oxidative coupling or hydrosilylation, and precursors used for this process step are in particular those for which at least one R³ radical in each case is an olefinically unsaturated group, for example a vinyl group.

This is possible both in a hydrolytic process, as described further up, and in an anhydrous process.

If the groups of the formula (R³₃SiO_{1/2})_{f} are generated under hydrolytic conditions by using a chlorosilane precursor of formula (X), symmetric disiloxanes are also formed therefrom in the course of the synthesis, but these are splittable again under the conditions of acidic hydrolysis and are therefore still available as terminating groups for reactions with silanol and silicon-bonded alkoxy groups or else carbinol groups, where the silanol groups and the silicon-bonded alkoxy groups form on the organopolysiloxane when it is prepared by a hydrolytic process and the carbinol groups may be present as phenolic OH groups.

The chlorosilane precursors for the groups of the formula (R³₃SiO_{1/2})_{f} can also be used in excess here since any remaining disiloxanes can generally be distilled off after the synthesis has ended, particularly when they are substituted exclusively or predominantly by short-chain alkyl radicals, in particular methyl radicals.

The chlorosilanes or disiloxanes that form these terminal groups can also be added separately in a final synthesis step, and the reduction of the silanol groups can be brought about in a controlled manner by means of acidic hydrolytic conditions. It is advantageous here always to use an excess of terminating chlorosilanes and to remove the disiloxanes formed by distillation. It is particularly advantageously possible for this purpose to use vinyldimethylchlorosilane, divinylmethyl-chlorosilane, trivinylchlorosilane, methacryloyloxypropyl-dimethylchlorosilane, bismethacryloyloxypropylinethylchloro-silane, trismethacryloyloxypropylchlorosilane, acryloyloxy-propyldimethylchlorosilane, bismethacryloyloxypropylmethyl-chlorosilane, trismethacryloyloxypropylchlorosilane, since the disiloxanes that form therefrom are particularly easily removable by distillation. Alternatively, it is of course also possible to use the disiloxanes straight away and to choose hydrolytic conditions, in which case it is necessary to add a sufficient amount of catalytic acid, preferably hydrochloric acid. Typically, in this case, between 50 and 1000 ppm of hydrochloric acid is used, based on the amount of siloxane in the reaction mixture.

This final step can also be performed under anhydrous conditions by adding the chosen chlorosilane, preferably vinyldimethylchlorosilane, divinylmethylchlorosilane, trivinylchlorosilane, methacryloyloxypropyldimethylchloro-silane, bismethacryloyloxypropylmethylchlorosilane, trismethacryloyloxypropylchlorosilane, acryloyloxypropyl-dimethylchlorosilane, bismethacryloyloxypropylmethylchloro-silane or trismethacryloyloxypropylchlorosilane to the copolymer dissolved in an inert organic solvent from the oxidative coupling of (VII) with (VIIIa) or (VIIIb), and performing the reaction without water in the presence of an auxiliary base, where auxiliary bases used are preferably basic metal salts and nitrogen compounds.

Suitable auxiliary bases used to trap the hydrogen halide formed are basic salts or nitrogen compounds such as amines, ureas, imines, guanidines and amides. Examples of basic salts are sodium hydride, sodium amide, sodium carbonate, sodium hydrogencarbonate, potassium carbonate, potassium hydrogen-carbonate, calcium carbonate, calcium hydrogencarbonate, calcium oxide, magnesium oxide, magnesium carbonate. Examples of nitrogen compounds are ammonia, ethylamine, butylamine, triethylamine, trimethylamine, tributylamine, N,N-dimethyldecylamine, triisooctylamine, urea, tetramethylurea, guanidine, tetramethylguanidine, N-methylimidazole. N-ethylimidazole, piperidine, pyridine, picoline, N-methylmorpholine. Amine compounds used are preferably those in which the nitrogen atoms do not bear hydrogen atoms.

The auxiliary base is preferably used at least in an equimolar amount based on the halosilane. For each molar equivalent of halosilane, preferably at least 0.5 base equivalent, more preferably at least 1.0 base equivalent, especially at least 2.0 base equivalents, of auxiliary base is/are used. It is also possible to use greater amounts of auxiliary base, for example if it is to serve simultaneously as solvent. However, this usually does not bring any benefit, but reduces the space-time yield and hence the economic viability of the process. The halosilane is preferably added to the anhydrous reaction mixture from the first step of the process and then the auxiliary base is metered in. This procedure can optionally also be reversed, such that the auxiliary base is first added to the reaction mixture from the first synthesis step and then the halosilane is metered in.

It is also possible to use mixtures of two or more auxiliary bases.

The reaction of the halosilane(s) of the formula (XII) with the silanol radicals of the polyorganosiloxane species or the phenolic OH radicals of the copolymer from the oxidative coupling of (VII) with (VIIIa) or (VIIIb) is preferably effected at a temperature of at least −20° C., more preferably of at least 0° C. especially of at least 10° C. The maximum permissible temperature additionally arises from the boiling point of the solvent used and of the halosilane(s) of the formula (X), where the reaction temperature preferably does not exceed 200° C., more preferably 175° C., especially 150° C.

The reaction mixture can be cooled or heated if required; it is optionally possible to adjust individual reaction components to temperature beforehand, before they are reacted with one another, for example in order to be able to utilize the heat of reaction. The process can be performed either batchwise in stirred reactors or continuously in column reactors, loop reactors, fluidized bed reactors or tubular reactors. Any low molecular weight siloxanes formed in the reaction can be separated by distillation if required from the reaction mixture. The halide salts formed in the reaction can be decanted off, filtered off or centrifuged off, or dissolved in water and separated off. For the subsequent aqueous workup, it is possible to adjust the amount of solvent already present if required, for example in order to facilitate the phase separations by establishment of differences in density, or to add further solvents having minimum solubility or miscibility with water, especially a maximum of 5% by weight at 25° C. Any excess of halosilane of the formula (X) present is optionally removed by distillation before the aqueous workup.

Suitable aprotic solvents are especially aromatic hydrocarbon solvents such as benzene, toluene, o-xylene, m-xylene, p-xylene, ethylbenzene or mixtures thereof. The suitability of the solvent is determined by its dissolution capacity for copolymers of the formula (I) formed. The solvent must sufficiently dissolve the copolymer of the formula (I) formed, must not be miscible with water, i.e. must itself not be able to dissolve more than 5% by weight of water, and must not take part in the reaction.

It may be necessary to determine the suitability of the solvent by suitable experiments. Aromatic solvents best meet the conditions mentioned and are therefore preferred.

The copolymers of the formula (I) are chemically curable, meaning that they can be cured by a chemical reaction to give a crosslinked insoluble network. The curing is effected via the olefinically unsaturated groups that are described further up. Possible chemical crosslinking reactions include the known reactions according to the prior art, especially free-radical crosslinking, which can be initiated either using suitable radiation sources such as UV light or by means of unstable chemical compounds that break down to free radicals, and addition crosslinking, for example by hydrosilylation of the olefinically unsaturated group having an Si—H function in the presence of a suitable hydrosilylation catalyst.

In order to achieve sufficient curing, a sufficient amount of functional groups have to be present. Depending on the polyorganosiloxane molecule used in accordance with the invention, it is necessary for there to be at least an average of 1.0 functional group in order to achieve sufficient curing; preferably an average of at least 1.1 and especially an average of at least 1.2 functional groups are present per polyorganosiloxane molecule of the invention. The functional groups here may be different, such that, for example, one portion of the functional groups is an Si—H group and another portion of the functional groups is an olefinically unsaturated group which is free-radically curable or hydrosilylatable. It should be noted here that, according to the invention, there must always be a minimum proportion of the olefinically or acetylenically unsaturated groups. If only one type of functional groups is present, for example solely olefinically or acetylenically unsaturated functional groups that are free-radically curable, the corresponding number of these functional groups must be present. For the purposes of copolymerization to give a homogeneous matrix, it should be ensured that copolymerizability of the chosen olefinic and acetylenic groups is sufficient. A combination of olefinic groups that are not mutually copolymerizable is also possible, provided that the matrix achieved, composed of two or optionally more individual polymers, remains mutually compatible and does not form separate phases that separate from one another into distinguishable domains. It has to be ensured here that each of the individual polymers itself is chemically curable, such that the whole matrix that forms is chemically cured after crosslinking.

Examples of suitable initiators in order to initiate the free-radical polymerization here especially include examples from the field of the organic peroxides, such as di-tert-butyl peroxide, dilauryl peroxide, dibenzoyl peroxide, dicumyl peroxide, cumyl peroxyneodecanoate, tert-butyl peroxyneo-decanoate, tert-amyl peroxypivalate, tert-butyl peroxypivalate, tert-butyl peroxyisobutyrate, tert-butyl peroxy-3,5,5-trimethylhexanoate, tert-butylcumyl peroxide, tert-butyl peroxyacetate, tert-butyl peroxybenzoate, 1,1-di-tert-butylperoxycyclohexane, 2,2-di(tert-butylperoxy)butane, bis(4-tert-butylcyclohexyl) peroxydicarbonate, hexadecyl peroxydicarbonate, tetradecyl peroxydicarbonate, dibenzyl peroxydicarbonate, diisopropylbenzene dihydroperoxide, [1,3-phenylenebis(1-methylethylidene)]bis[tert-butyl]peroxide, 2,5-dimethyl-2,5-di(tert-butylperoxy)hexane, dicetyl peroxydicarbonate, acetylacetone peroxide, acetylcyclohexane-sulfonyl peroxide, tert-amyl hydroperoxide, tert-amyl peroxy-2-ethylhexanoate, tert-amyl peroxy-2-ethylhexylcarbonate, tert-amyl peroxyisopropylcarbonate, tert-amyl peroxyneodecanate, tert-amyl peroxy-3,5,5-trimethylhexanoate, tert-butyl monoperoxymaleate, where this enumeration is merely illustrative and nonlimiting. It is optionally also possible to use mixtures of different initiators for free radical reactions. The suitability of an initiator or initiator mixture for free radical reactions depends on its breakdown kinetics and the requirements to be met. Taking sufficient account of these boundary conditions, the person skilled in the art will succeed in selecting a suitable initiator.

In the case of formulations containing not only olefinically and acetylenically unsaturated groups but also silicon-bonded hydrogen, there is the possibility of curing by a hydrosilylation reaction. Suitable catalysts for promotion of the hydrosilylation reaction are the known catalysts from the prior art.

Examples of such catalysts are compounds or complexes from the group of the transition metals comprising platinum, ruthenium, iridium, rhodium and palladium, preferably metal catalysts from the group of the platinum metals or compounds and complexes from the group of the platinum metals. Examples of such catalysts are metallic and finely divided platinum which may be present on supports such as silicon dioxide, aluminum oxide or activated carbon, compounds or complexes of platinum such as platinum halides, e.g. PtCl₄, H₂PtCl₆×6H₂O, Na₂PtCl₄×4H₂O, platinum-olefin complexes, platinum-alcohol complexes, platinum alkoxide complexes, platinum-ether complexes, platinum-aldehyde complexes, platinum-ketone complexes, including reaction products of H₂PtCl₄×6H₂O and cyclohexanone, platinum-vinylsiloxane complexes, such as platinum-1,3-divinyl-1,1,3,3-tetramethyldisiloxane, with or without a content of detectable inorganically bound halogen, bis(gamma-picoline)platinum chloride, trimethylenedipyridineplatinum chloride, dicyclopentadieneplatinum dichloride, dimethylsulfoxy-ethenylplatinum(II) dichloride, cyclooctadieneplatinum dichloride, norbornadieneplatinum dichloride, gamma-picolineplatinum dichloride, cyclopentadieneplatinum dichloride, and reaction products of platinum tetrachloride with olefin and primary or secondary amine or primary and secondary amine such as the reaction product of 1-octene-dissolved platinum tetrachloride with sec-butylamine or ammonium-platinum complexes. In a further embodiment of the process of the invention, complexes of iridium with cyclooctadienes, for example μ-dichlorobis(cyclooctadiene)-diiridium(I) are used.

This enumeration is merely illustrative and nonlimiting. The development of the hydrosilylation catalysts is a dynamic field of research which is constantly discovering new active species which can naturally likewise be used here.

The hydrosilylation catalyst preferably comprises compounds or complexes of platinum, preferably platinum chlorides and platinum complexes, especially platinum-olefin complexes and more preferably platinum-divinyltetramethyldisiloxane complexes.

In the process of the invention, the hydrosilylation catalyst is used in amounts of 2 to 250 ppm by weight based on the overall compositions, preferably in amounts of 3 to 150 ppm, especially in amounts of 3 to 50 ppm.

In a preferred embodiment, the copolymers of the formula (I) are applied to a metal substrate. The copolymers of the formula (I) are particularly suitable for use as binders and/or as adhesion promoters for the production of metal-plated laminates, especially for electronic applications, especially for metal foil-clad laminates and especially for use in high-frequency applications, very particularly those that are run at frequencies of 1 GHz or higher. Particular preference is given to the use of metal foil-clad electrolaminates as used for production of printed circuit boards in electronic devices, especially for high-frequency applications. Said metal foil-clad electrolaminates may, but need not, comprise reinforcing materials. This means that they may, for example, contain reinforcing weaves such as fiber weaves or nonwovens, or they may be free of these. If a reinforcing material is present, it is preferably arranged in layers. A reinforcing layer may be formed here from a multitude of different fibers. Such reinforcing layers help to control shrinkage characteristics and give elevated mechanical strength.

If a reinforcing layer is included, the fibers that form this layer may be selected from a multitude of different options. Nonlimiting examples of such fibers are glass fibers, for example E glass fibers, S glass fibers and D glass fibers, silica fibers, polymer fibers, for example polyetherimide fibers, polysulfone fibers, polyetherketone fibers, polyester fibers, polycarbonate fibers, aromatic polyamide fibers or liquid-crystalline fibers. The fibers may have a diameter of 10 nm to 10 μm. The reinforcing layer has a thickness of not more than 200 μm, preferably not more than 150 μm.

A preferred embodiment is the use of the copolymers of the formula (I) as binders or cobinders together with organic binders for production of metal foil-clad laminates of glass fiber composites for further production of printed circuit boards. The preferred metal is copper.

For the inventive use of the copolymers of the formula (I), these may be used as the sole binder. They may also be used in a blend with polyorganosiloxanes, organic monomers, oligomers and polymers. Organic monomers, oligomers and polymers typically used for the purpose include polyphenylene ethers, bismaleimides, bismaleimide-triazine copolymers, hydrocarbon resins, both aliphatic hydrocarbon resins, for example polybutadiene, and aromatic hydrocarbon resins, for example polystyrene, and also hybrid systems having both aliphatic and aromatic character, for example styrene-polyolefin copolymers, where the form of the copolymers is again fundamentally unrestricted, epoxy resins, cyanate ester resins and possibly others, where the selection should be considered to be illustrative and nonlimiting.

Preferred organic monomers, oligomers and polymers are oligomeric and polymeric polyphenylene ethers, monomeric, oligomeric and polymeric bismaleimides, oligomeric and polymeric hydrocarbon resins, and bismaleimide-triazine copolymers. It is optionally possible here to use the organic monomers, oligomers and polymers in a mixture with one another. The proportion of the organic monomers, oligomers and polymers in the formulations with the copolymers of the formula (I), if the organic components are included, is between 10% and 90% based on the mixture of the copolymers of the formula (I) and the organic monomers, oligomers and polymers as 100%, preferably 20-90%, especially 30-80%. In addition, both the copolymers of the formula (I) and mixtures thereof with organic monomers, oligomers or polymers may be dissolved in further organic monomers, optionally having olefinically or acetylenically unsaturated groups, as reactive diluents, for example styrene, alpha-methylstyrene, para-methylstyrene and vinylstyrene, chloro- and bromostyrene. It is likewise possible to use typical non-reactive solvents for dissolution of the copolymers of the formula (I) and optionally mixtures thereof with organic monomers, oligomers and polymers, for example aliphatic or aromatic solvents such as aliphatic mixtures having particular boiling ranges, toluene, xylene, ethylbenzene or mixtures of the same aromatics, ketones such as acetone, methyl ethyl ketone, cyclohexanone, carboxylic esters such as ethyl acetate, methyl acetate, ethyl formate, methyl formate, methyl propionate, ethyl propionate, where good solubility, especially of the mixtures of polyorganosiloxanes of the formula (I), with organic monomers, oligomers and polymers is most likely to be achieved in aromatic solvents such as toluene, xylene, ethylbenzene and mixtures thereof.

If polyorganosiloxanes are used as a further mixture component together with the copolymers of the formula (I) and optionally further organic monomers, oligomers or polymers, it is essential that polyorganosiloxanes that are compatible with the organic components of choice and do not lead to phase separations are chosen. In these cases, in general, phenyl-richer polyorganosiloxanes should generally be used since phenyl groups increase compatibility with the organic components. Aromatic-richer polyorganosiloxanes should especially be used together with relatively aromatic-rich organic polymers such as polyphenylene ethers or aromatic hydrocarbon resins, where a contribution is made to establishment of compatibility both by the bridging aromatic groups and by aromatic substituents bonded terminally to silyl units.

The exact amount of aromatic groups needed to establish compatibility of the polyorganosiloxanes with a particular selection of organic binders must be ascertained depending on the selection of organic binders.

In the same way as it is possible to mix two or more organic polymers that are optionally selected from different polymer classes and to use them in the binder formulation. It is also possible to combine two or more polyorganosiloxanes with one another in a binder formulation. Moreover, it is possible and within the scope of the invention to mix two or more different copolymers of the formula (I) with one another to give a binder. Mixtures of polyorganosiloxanes, copolymers of the formula (I) and further organic polymers may also result here from the reaction that forms the copolymers of the formula (I) if there are still fractions of unreacted polyorganosiloxanes of the formula (VII) or (IX) after the reaction has ended, possibly alongside polyarylene ether units not bonded to the polyorganosiloxane skeleton from the polymerization of the polyarylene ether precursors (VIIIa) and (VIIIb) or unhydrolyzed polyarylene ethers of the formulae (Xa) and (Xb). Such mixtures and the use thereof are within the scope of the invention, provided that they also contain copolymers of the formula (I).

It is easy to determine compatibility of one or more polyorganosiloxanes with one or more organic oligomers or polymers by mixing a mixture of the organic binder(s) with the polyorganosiloxane(s) advantageously in a solvent that dissolves all the components chosen, then removing the solvent by prior art methods, for example by distillation or spray drying, and assessing the residue obtained visually or with the aid of microscopy methods, if necessary electron microscopy methods. Compatible mixtures are recognizable in that there are no silicon domains that can be separated from the organic constituents and are recognizable as a separate phase.

The use of further formulation components, such as additives that may optionally include silanes, for example antifoams and deaerators, wetting and dispersing agents, levelling agents, compatibilizers, adhesion promoters, curing initiators, catalysts, stabilizers, fillers including pigments, dyes, inhibitors, flame retardants, crosslinking aids, etc. is within the scope of the invention, and the selection of such components is fundamentally unrestricted. Apart from compatibility tests for the purpose of suitable miscibility characteristics, it may also be necessary to test for compatibility with regard to reactivity, in order both to prevent premature gelation and to ensure that sufficiently rapid polymerization or copolymerization of all components with one another is achieved during curing, and likewise to test for sufficient wetting and possibly further properties. This should be noted and included if necessary within the scope of creating the formulation.

Examples of usable fillers are ceramic fillers, for instance silicas, for example precipitated silicas or fumed silicas, which may be either hydrophilic or hydrophobic and are preferably hydrophobic, and which may additionally also be functionally and optionally reactively modified with organic groups on their surface, quartz, which may optionally be surface-treated or surface-functionalized such that it can bear reactive functional groups on the surface, aluminum oxides, aluminum hydroxides, calcium carbonate, talc, mica, clay, kaolin, magnesium sulfate, carbon black, titanium dioxide, zinc oxides, antimony trioxide, barium titanate, strontium titanate, corundum, wollastonite, zirconium tungstate, ceramic hollow beads, aluminum nitride, silicon carbide, beryllium oxide, magnesium oxide, magnesium hydroxide, solid glass beads, hollow glass beads and boron nitride. Further fillers used may be core-shell particles of different materials, for instance superficially silica-coated silicone resin beads, polymer-coated elastomer particles, where the elastomer particles may optionally also be silicone elastomers, and a typical example of a surface coating of such an elastomer particle is a polymethylmethacrylate shell. The ceramic fillers preferably have particle sizes expressed as the D₉₀ value of 0.1 μm to 10 μm. Fillers are preferably present in amounts of 0.1 to 60 percent by weight, preferably of 0.5 to 60 percent by weight, especially of 1 to 60 percent by weight, based on the overall binder formulation consisting of binder(s), reactive monomers, additives and fillers as 100%. In other words, the amount of any unreactive solvent used is not counted.

Among the fillers, particular emphasis is given to those that are thermally conductive. These are aluminum nitride, boron nitride, silicon carbide, diamond, graphite, beryllium oxide, zinc oxide, zirconium silicate, magnesium oxide, silicon oxide and aluminum oxide.

In principle, the binder formulations may contain flame-retardant additives in an amount of typically 5 to 25 percent by weight. However, it is a characteristic of the copolymers of the formula (I) that they reduce the need for flame-retardant additives since the polyorganosiloxane component in the copolymers of the formula (I) itself already shows flame-retardant properties. Polysilsesquioxanes and siloxanes are known for flame-retardant properties, as can be discerned from the discussion of the prior art as background to this invention. It is part of the prior art that they are themselves used as flame-retardant additives. It is therefore a particular advantage of the present invention that it is possible here to combine the function of a binder suitable for high-frequency applications with the function of flame retardancy. Depending on the amount of polyorganosiloxanes used in the copolymers of the formula (I), it is therefore possible to reduce the amount of flame-retardant additives. In the case of an amount of at least 20% by weight based on the overall mixture of all binders and reactive organic monomers used, the amount of flame-retardant additives is preferably only 0 to 10 percent by weight, more preferably 0 to 8 percent by weight, especially 0 to 5 percent by weight, meaning that it is possible when the copolymers of the formula (I) are used, depending on the selection of the organopolysiloxane and the amount used, to dispense with the use of a flame-retardant additive.

Typical examples of flame-retardant additives are hydrates of the metals Al, Mg, Ca, Fe, Zn, Ba, Cu or Ni and borates of Ba and Zn. The flame-retardant additives may have been surface-treated, in which case they may optionally have reactive groups on the surface. The flame-retardant additives may also be halogenated organic flame-retardant additives, for example hexachloroendomethylenetetrahydrophthalic acid, tetrabromophthalic acid or dibromoneopentyl glycol. Examples of further flame-retardant additives are melamine cyanurate, phosphorus-containing components, such as phosphinates, diphosphinates, phosphazenes, vinylphosphazenes, phosphonates, phosphaphenanthrene oxides, finely divided melamine polyphosphates.

Further examples of brominated flame-retardant additives are bispentabromophenylethane, ethylenebistetrabromophthalimide, tetradecabromodiphenoxybenzene, decabromodiphenyl oxide or brominated polysilsesquioxanes. Some flame-retardant additives have synergistic effects. This is the case, for example, for the combination of halogenated flame-retardant additives with antimony trioxide.

Further examples of other components are antioxidants, stabilizers against degradation by weathering, lubricants, plasticizers, colorants, phosphorescent agents or other agents for the purposes of labeling and traceability, and antistats.

The copolymers of the formula (I) are preferably crosslinked in a step of the use as binders or cobinders.

Crosslinking aids employed are in particular polyunsaturated free-radically curable or hydrosilylatable monomers and oligomers, as illustrated in nonlimiting examples which follow. These include, for example, diolefinically unsaturated components, for example symmetrically olefinically unsaturated disubstituted disiloxanes, such as 1,1,3,3-tetramethyl-1,3-divinyldisiloxane, 1,1,3,3-tetramethyl-1,3-dipropylmethacryloyldisiloxane, diolefinically unsaturated disubstituted, for example diallyl-, divinyl-, diacryloyl- or dimethacryloyl-substituted, organic monomers or oligomers, for example conjugated and nonconjugated dienes, such as 1,9-decadiene, 1,3-butadiene. These likewise include triolefinically unsaturated monomers or oligomers such as 1,2,4-trivinylcyclohexane, triallyl cyanurates or triallyl isocyanurates, tri(meth)acrylates, for example trimethylolpropane trimethacrylate. These likewise include tetraunsaturated substituted monomers and oligomers, for example 2,4,6,8-tetramethyl-2,4,6,8-tetravinylcyclotetrasiloxane, 2,4,6,8-tetraphenyl-2,4,6,8-tetravinylcyclotetrasiloxane, 2,2-bis[[(2-methyl-1-oxoallyl)-oxy]methyl]-1,3-propanediyl bismethacrylate (pentaerythritol tetramethacrylate), tetraallyl orthosilicate, tetraallyl cis,cis,cis,cis-1,2,3,4-cyclopentanetetracarboxylate, tetraallylsilanes, glyoxal bis(diallyl acetal).

Since hydrosilylation curing is also conceivable as well as free-radical curing, it is also possible for poly-Si—H-functional components to act as crosslinkers, for example 1,1,3,3-tetramethyl-1,3-disiloxane, 2,4,6,8-tetramethyl-cyclotetrasiloxane, 1,4-bis(dimethylsilyl)benzene or polycatenated Si—H-functional and/or terminally Si—H-functional oligo- and polyorganosiloxanes.

Useful catalysts or initiators for the free-radical curing of the binder formulations composed of copolymers of the formula (I) and polyorganosiloxanes, organic monomers, oligomers and polymers are the same as already mentioned further up, i.e. peroxides in particular. Additionally suitable for initiation of free-radical curing both of the copolymers of the formula (I) on their own and of the binder formulations described are further free-radical initiators, for example azo components, for example α,α′-azobis(isobutyronitrile), redox initiators, for example combinations of peroxides such as hydrogen peroxide and iron salts, or azides such as acetyl azide.

For the application of the invention, the copolymers of the formula (I) or the formulations comprising them may be used either in solvent-free form or as a solvent-containing formulation. In general, they are used as a solvent-containing formulation in order to facilitate the homogeneous interdistribution of all components of the formulation and the wetting and impregnation of any reinforcing layer used. In general, a reinforcing layer is used as well. It is preferably a glass fiber weave. The reinforcing layer can be impregnated by impregnating application of the formulation, for which various technical solutions are available, optionally including continuous methods, and the selection thereof for production of the metal-clad laminates of the invention is in no way restricted. Nonlimiting examples of coating techniques are dipping, optionally of webs of the reinforcing material via roller systems in continuous processes, spraying, flow coating, knife coating, etc. It is an advantage of the present invention that all technologies available can be employed without restriction and modification, and no specific new process is required for the use of the copolymers of the formula (I). In this respect, the present invention, in the production of the metal-clad laminates, is entirely within the scope of the available prior art. What is new is the use of the copolymers of the formula (I) for the production of the metal-clad laminates in question, which is unknown to date.

The impregnation is followed by a drying step in which any solvent used is removed. For the drying process too, prior art methods are employed. These especially include thermally induced evaporation with or without reduced pressure. Through suitable adjustment of reactivity and of tackiness of the binder mixture used, what are obtained after this step, under suitable conditions, for example cooling, are storable composite materials that can optionally be processed further at a later juncture. In a last step of the process, the binder formulation is polymerized, again by prior art methods. Any initiators included for the free-radical polymerization are heated here above their breakdown temperature, such that they break down to form free radicals and initiate the free-radical polymerization of the binder formulation. In principle, methods of radiative curing are also employable.

If hydrosilylation curing is used rather than free-radical polymerization, a temperature to be employed in this step has to be suitable for deactivation of the inhibitor included with the hydrosilylation catalyst used, and for release of the catalytic activity of the hydrosilylation catalyst.

This step is generally effected at an elevated temperature of preferably 60 to 390° C., more preferably of 70 to 250° C., especially of 80 to 200° C., where the temperature is effective for a period of preferably 5 to 180 min, more preferably 5 to 150 min, especially 10 to 120 min. Moreover, it is customary to employ elevated pressure in this step. Customary pressures are in the range from 1 to 10 MPa, more preferably from 1 to 5 MPa, especially from 1 to 3 MPa.

In this second step, the composite material is laminated with a conductive metal layer in that a layer of at least one selected metal is applied on one or both sides of the composite material composed of reinforcing layer and binder formulation before curing takes place. In other words, between the first step consisting of impregnation and drying and the second step comprising the chemical curing of the binder formulation, the composite from the first step is laminated with at least one type of conductive metal.

Useful conductive metals especially include at least one from the following selection: copper, stainless steel, gold, aluminum, silver, zinc, tin, lead and transition metals. The thickness of the conductive layer, and the shape, size or surface texture thereof, are fundamentally unlimited. The conductive metal layer preferably has a thickness of 3 to 300 μm, more preferably of 3 to 250 μm, especially of 3 to 200 μm. The thickness of the two layers of at least one type of conductive metal, if two layers are used, may vary and need not be identical. It is particularly preferable that the conductive metal is copper and that, in the case that two conductive layers of conductive metal are used, both layers are copper. The conductive metal is preferably used in the form of a foil of the metal in question. The arithmetic mean roughness Ra of the metal foil used is preferably not more than 2 μm, more preferably not more than 1 μm, especially not more than 0.7 μm. The lower the surface roughness, the better the suitability of the respective foil for use in high-frequency applications, which are the preferred aim of the present invention. In order to improve the adhesion between the conductive metal layer and the composite composed of binder formulation and reinforcing layer, it is possible if necessary to use various prior art methods, for example the use of an adhesion-promoting layer, the electrolytic deposition of the metal layer on the composite composed of binder formulation and reinforcing layer, or gas phase deposition. The layer of conductive metal may rest directly on the composite composed of binder formulation and reinforcing layer or be bonded thereto by an adhesion-promoting layer.

If no reinforcing layer is included, a layer of the binder formulation comprising the polyorganosiloxanes of the formula (I) is produced by deposition of a layer of binder formulation on a carrier, for example a separation film or separation plate, where a suitable material for the carrier is in principle any from which the dried or cured binder formulation is detachable again at a later juncture, for example polytetrafluoroethylene, polyesters and the like. Detachability and film-forming properties on the respective carrier material should be determined individually depending on the binder composition. The statements made with regard to the process remain equally applicable to this reinforcement-free variant.

The reinforced or unreinforced composite materials from the first step and the laminated composite materials from the second step can be used to create multilayer structures in that two or more layers of the composite material from the first step are stacked one on top of another, for example alternately with the clad laminates from the second step, and the as yet uncured composite materials from the first step are then cured in a process corresponding essentially to the procedure for creation of the metal-clad laminates. For creation of thicker layers, it is also possible here to stack two or more layers of the reinforced or unreinforced composites from the first step one on top of another in direct succession.

The copolymers of the formula (I), aside from the production of metal-clad laminates, especially electrolaminates, can additionally be used in anticorrosion formulations, especially for use for the purpose of corrosion protection at high temperature.

Moreover, the copolymers of the formula (I) and formulations comprising them can also be used for corrosion protection of reinforcing steel in reinforced concrete. Corrosion-inhibiting effects in reinforced concrete are achieved when both the copolymers of the formula (I) and formulations comprising them are introduced into the concrete mixture before they are shaped and cured, and when the copolymers of the formula (I) or formulations comprising them are applied to the surface of the concrete after the concrete has cured.

Aside from the purpose of corrosion protection on metals, the copolymers of the formula (I) can also serve for manipulation of further properties of formulations containing the organopolysiloxanes of the invention or of solids or films that are obtained from formulations containing the copolymers of the formula (I), for example:
control of electrical conductivity and electrical resistance
control of the leveling properties of a formulation
control of the gloss of a moist or cured film or an object
increase in weathering stability
increase in chemical resistance
increase in shades stability
reduction of tendency to chalking
reduction or increase in static and sliding friction on solids or films obtained from formulations comprising copolymers of the formula (I)
stabilization or destabilization of foam in the formulation comprising the formulation
improvement in adhesion of the formulation comprising the copolymers of the formula (I) to substrates
control of filler and pigment wetting and dispersion characteristics
control of rheological properties of the formulation comprising the organopolysiloxanes of the invention
control of mechanical properties, for example flexibility, scratch resistance, elasticity, extensibility, bendability, friction characteristics, resilience characteristics, hardness, density, tear propagation resistance, compression set, behavior at different temperatures, coefficient of expansion, abrasion resistance and further properties, such as thermal conductivity, combustibility, gas permeability, resistance to steam, hot air, chemicals, weathering and radiation, sterilizability, of solids or films obtainable comprising the copolymers of the formula (I) or formulations comprising them
control of electrical properties, for example dielectric loss factor, breakdown resistance, dielectric constant, tracking current resistance, arcing resistance, surface resistance, specific breakdown resistance,
flexibility, scratch resistance, elasticity, extensibility, bendability, breaking characteristics, resilience characteristics, hardness, density, tear propagation resistance, compression set, behavior at different temperatures of solids or films obtainable from the formulation comprising the copolymers of the formula (I).

Examples of applications in which the copolymers of the formula (I) can be used in order to manipulate the above-designated properties are the production of coating materials and impregnations and of coatings and coverings obtainable therefrom on substrates, such as metal, glass, wood, mineral substrate, synthetic and natural fibers for production of textiles, carpets, floor coverings, or other goods producible from fibers, leather, plastics such as films, and shaped articles. The copolymers of the formula (I), given appropriate selection of the formulation components, may also be used in formulations as additive for the purpose of defoaming, promoting leveling, hydrophobization, hydrophilization, filler and pigment dispersion, filler and pigment wetting, substrate wetting, promotion of surface smoothness, reduction of static and sliding friction on the surface of the cured mass obtainable from the additized formulation. The copolymers of the formula (I) may be incorporated into elastomer masses in liquid or in cured solid form. They may be used here for the purpose of reinforcement or for improvement of other use properties, such as control of transparency, of heat resistance, of tendency to yellowing, or of weathering resistance.

All the above symbols in the above formulae are each defined independently of one another. In all formulae, the silicon atom is tetravalent.

### EXAMPLES

The examples that follow serve for further elucidation of the invention. They should be regarded as illustrative, not limiting.

All percentages are based on weight. Unless stated otherwise, all manipulations are performed at room temperature of 23° C. and under standard pressure (1.013 bar).

Unless stated otherwise, all data describing product properties are applicable at room temperature of 23° C. and under standard pressure (1.013 bar).

The apparatuses are commercial laboratory equipment, as supplied commercially by numerous equipment manufacturers.
Ph means a phenyl radical=C₆H₅—
Me means a methyl radical=CH₃—. Me₂ correspondingly means two methyl radicals.
PPE means polyphenylene ether.
HCl means hydrogen chloride.

In the present text, substances are characterized by reporting of data that are obtained by instrumental analysis. The underlying measurements are either conducted in accordance with publicly available standards or ascertained by specially developed methods. In order to assure clarity of the teaching imparted, the methods used are specified hereinafter.

In all examples, statements of parts and percentages are based on weight, unless stated otherwise.

### Viscosity:

Unless stated otherwise, viscosities are determined by rotational viscometry measurement according to DIN EN ISO 3219. Unless stated otherwise, all viscosity figures are applicable at 25° C. and standard pressure of 1013 mbar.

### Refractive Index:

Refractive indices are determined in the wavelength range of visible light, unless stated otherwise at 589 nm at 25° C. and standard pressure of 1013 mbar according to standard DIN 51423.

### Transmittance:

Transmittance is determined by UV/vis spectroscopy. An example of a suitable instrument is the Analytik Jena Specord 200.

The measurement parameters used are: range: 190-1100 nm, step width: 0.2 nm, integration time: 0.04 s, measurement mode: step operation. First, the reference (background) is measured. A quartz plate fixed to a sample holder (dimensions of the quartz plates: H×W about 6×7 cm, thickness about 2.3 mm) is placed into the sample beam path and measured against air. Thereafter, the sample is measured. A quartz plate with the sample applied that has been secured to the sample holder—layer thickness of applied sample about 1 mm—is placed into the sample beam path and measured against air. The internal offset against the background spectrum gives the transmission spectrum of the sample.

### Molecule Compositions:

Molecule compositions are determined by nuclear resonance spectroscopy (for terminology see ASTM E 386: high-resolution magnetic nuclear resonance spectroscopy (NMR): terms and symbols), with measurement of the ¹H nucleus and the ²⁹Si nucleus.

### Description of ¹H NMR Measurement

Solvent: CDCl3, 99.8% d
Sample concentration: about 50 mg/l ml CDCl3 in 5 mm NMR tube

Measurement without addition of TMS, spectral referencing of —CHCl3 radical in CDCl3 at 7.24 ppm
Spectrometer: Bruker Avance I 500 or Bruker Avance HD 500
Sample head: 5 mm BBO sample head or SMART sample head (from Bruker)

### Measurement Parameters:

Pulprog=zg30
TD=64 k
NS=64 or 128 (depending on the sensitivity of the sample head)
SW=20.6 ppm
AQ=3.17 s
D1=5 s
SFO1=500.13 MHz
O1=6.175 ppm

### Processing Parameters:

SI=32 k
WDW=EM
LB=0.3 Hz

Depending on the spectrometer type used, individual adjustments to the measurement parameters may be required.

### Description of ²⁹Si NMR Measurement

Solvent: C6D6 99.8% d/CCl4 1:1 v/v with 1% by weight of Cr(acac)₃ as relaxation reagent
Sample concentration: about 2 g/1.5 ml of solvent in 10 mm NMR tube
Spectrometer: Bruker Avance 300
Sample head: 10 mm 1H/13C/15N/29Si glass-free QNP sample head (from Bruker)

### Measurement Parameters:

Pulprog=zgig60
TD=64 k
NS=1024 (depending on the sensitivity of the sample head)
SW=200 ppm
AQ=2.75 s
D1=4 s
SFO1=300.13 MHz
O1=−50 ppm

### Processing Parameters:

SI=64 k
WDW=EM
LB=0.3 Hz

Depending on the spectrometer type used, individual adjustments to the measurement parameters may be required.

### Molecular Weight Distributions:

Molecular weight distributions are determined as the weight average Mw and as the number average Mn, by employing the method of gel permeation chromatography (GPC, or size Exclusion Chromatography (SEC)) with polystyrene standard and refractive index detector (RI detector). Unless stated otherwise, THF is used as eluent and DIN 55672-1 is applied. Polydispersity is the quotient Mw/Mn.

### Glass Transition Temperatures:

Glass transition temperature is determined by dynamic differential calorimetry (differential scanning calorimetry, DSC) according to DIN 53765, perforated crucible, heating rate 10 K/min.

### Determination of Particle Size:

Particle sizes were determined by the method of dynamic light scattering (DLS) with determination of the zeta potential.

The following auxiliaries and reagents were used for the determination:
10×10×45 mm polystyrene cuvettes, disposable Pasteur pipettes, ultrapure water.

The sample to be analyzed is homogenized and introduced into the analytical cuvette in bubble-free form.

Measurement is effected at 25° C. after an equilibration time of 300 s with high resolution and automatic adjustment of measurement time.

The values reported are always based on D(50). D(50) should be regarded as the volume average particle diameter at which 50% of all the particles analyzed have a volume-average diameter less than the D(50) shown.

### Determination of Dielectric Properties: Df, Dk

Dielectric properties are determined according to IPC™ 650 2.5.5.13 with a Keysight/Agilent E8361A network analyzer by the split cylinder resonator method at 10 GHz.

### Procedure for Microscopy:

The micro-/nanostructure was characterized by light microscopy or by transmission electron microscopy.

### Light Microscopy:

Sample preparation: 1 drop of sample (undiluted) on microscope slide; covered with cover slip Instrument: LEICA DMRXA2 with LEICA DFC420 CCD camera (2592×1944 pixels)
Image: transmitted light—interference contrast, various enlargement levels

### Transmission Electron Microscopy:

Sample preparation: 1 drop of sample (dilution 1:20, adjustment necessary if required) on coated TEM grid; addition of a contrast agent if required; drying at RT
Instrument: ZEISS LIBRA 120 with Sharp Eye CCD camera (1024×1024 pixels)
Image: excitation voltage 120 kV; TEM bright field; various enlargement stages

### Peel Strength Test:

Adhesion of the metal layers laminated onto the composite layers with or without reinforcing material was determined by method IPC-TM 650 2.4.8 “Peel Strength of Metallic Clad Laminates”, in the “as received” version, i.e. without thermal stress or exposure.

A 35 μm copper foil, mass 285±10 g/m², ten-point mean roughness Rz≤8 μm, arithmetic mean roughness Ra≤0.4 μm was laminated on either side of a composite layer of thickness 100 μm, with hardening and lamination by application of 2.0 MPa, 30 mm Hg column at 200° C. for 180 min.

### Example 1: Production of a Copolymer of the Invention by Oxidative Coupling

### 1.1. Production of a Hydroxyaryl-Functional Three-Dimensionally Crosslinked Polyorganosiloxane:

700 g of a polyorganosiloxane of percentage composition (in mol %) [(C₄H₅)SiO_{3/2}]_{55.8}[(C₆H₅)(OH)₂SiO_{1/2})_{2.0}(C₆H₅)(OH)SiO_{2/2}]_{32.9}[(CH₃)₂(H)SiO_{1/2}]_{9.3}, Mw=4391 g/mol. Mn=2014 g/mol is dissolved in 500 g of toluene. 90 g (=0.55 mol) of 4-allyl-2-methoxyphenol (eugenol, C₁₀H₁₂O₂, 164.2 g/mol) is added to that solution at room temperature of 23° C., and the mixture is homogenized by stirring with a laboratory paddle stirrer. The solution is heated up to internal temperature 80° C., and the heating output in the heating device is adjusted such that this temperature is kept constant. At this temperature, 0.6 g of a 4% platinum(IV)-containing solution of hexachloroplatinic acid in propanediol is added, meaning that 30 ppm of platinum(IV) is available for catalysis based on the sum total of the mass of the coreactants of 790 g. The solution is stirred for 2 hours, with unchanged heating output in the heating device. The reaction mixture is then cooled down to room temperature of 23° C. and filtered through a filter plate having a pore size of 1 μm. The solution is adjusted to a concentration of 50% toluene. A clear yellowish solution is obtained. The eugenol-functional silicone resin present, by ²⁹Si NMR, has the percentage composition (in mol %) [(C₆H₅)SiO_{3/2}]_{67.7}[(C₆H₅)(OH)₂SiO_{1/2}]_{1.0}[(C₆H₅)(OH)SiO_{2/2}]_{22.0} [(CH₃)₂(H)SiO_{1/2}]_{4.0}[(CH₃)₂(C₁₀H₁₃O₂)SiO_{1/2}]_{5.3} and, by SEC, a molecular weight of Mw=5596 g/mol and Mn=2281 g/mol. The number of hydroxyaryl-functional radicals based on all Si-bonded radicals is 3.7 mol %.

1.2. Oxidative Coupling of the Polyorganosiloxane from 1.1. with Phenols:

A constant stream of 0.5 m³/h of pure oxygen is set up through an initial charge of 200 ml of toluene, 0.82 g of copper(I) bromide and 21.8 g of di-n-butylamine. A mixture of 70 g of the polyorganosiloxane from 1.1. and 140 g (1.15 mol) of 2,6-xylenol (122.2 g/mol) in 200 ml of toluene is metered into this initial charge so as not to exceed an internal temperature of 30° C. After the metered addition has ended, the reaction mixture is stirred without further heating for a further 3 h. The reaction is stopped by the addition of 60 ml of acetic acid, and the water-soluble constituents are then removed by washing three times with 200 ml each time of demineralized water. After filtration through a 1 μm filter plate, the volatile constituents are removed at 120° C. under reduced pressure. As soon as a final vacuum of 10 mbar has been established, the mixture is heated for a further 2 h in order to remove all the constituents that are volatile under these conditions. 196 g of brown, clear product is obtained, which is solid at room temperature and can be dissolved easily both in toluene and xylene in a concentration of 50% by weight to give a brown, clear solution of low viscosity. By 29Si NMR spectroscopy, the resultant copolymer has the percentage composition (mol %): [(C₆H₅)SiO_{3/2}]_{66.3}[(C₆H₅)(OH)₂SiO_{1/2}]_{1.5}[(C₆H₅)(OH)SiO_{2/2}]_{23.0} [(CH₃)₂(H)SiO_{1/2}]_{3.8}[(CH₃)₂(C₁₀H₁₃O₂)SiO_{1/2}]_{0.3} [(CH₃)₂(poly-2,6-dimethylphenol)SiO_{1/2}]_{23.0}. The molecular weight is determined as Mw=17 234 g/mol, Mn=6798 g/mol. The proportion of poly-2,6-dimethylphenol units in the polyorganosiloxane-polyphenylene ether copolymer, by ¹H NMR, is 62% by weight. The proportion of OH groups in the copolymer (phenolic OH groups and silanol groups together) is 0.9% by weight. Given a molecular weight for OH of 17 g/mol, this means that 9 mol of OH is present in a molecule of Mw=17 234 g/mol.

This copolymer is referred to hereinafter as 1.2.1. and is not yet in accordance with the invention since it does not yet contain any olefinically unsaturated groups. These are inserted as described hereinafter.

A 50 percent by weight solution of copolymer 1.2.1. is prepared by dissolving 100 g of this copolymer (5.8 mmol) in 100 g of toluene. The residual water content of the solution is determined by Karl Fischer titration and is 364 ppm.

First 21.2 g (0.18 mol) of dimethylvinylchlorosilane and then 17.4 g (0.22 mol) of pyridine are metered in. The first metered addition takes 30 minutes, the second 45 minutes. An exothermic rise in temperature is observed. Here too, the temperature is limited to 40° C. by adjusting the metering rate. On completion of metered addition, the mixture is stirred for a further 60 minutes in order to complete the reaction.

After the reaction has ended, the mixture is washed three times with 200 ml each time of demineralized water and the aqueous phase is removed each time.

For phase separation, the mixture is stirred for 30 minutes in each case, then the stirrer is switched off and the phases can be separated. The aqueous phase is separated off at the bottom and is discharged. This operation is repeated until the residual HCl content in the organic phase determined by acid-base titration according to the prior art is <20 ppm.

If the aqueous phase should settle out at the top, rather than demineralized water, a 10% sodium chloride-containing aqueous solution is used for washing, and the procedure is otherwise the same.

After the last phase separation, the residual HCl content in the organic phase is <20 ppm. The solvent is removed by distillation at 120° C. and a reduced pressure of 10 mbar, as already described above. Here too, distillation is continued under these conditions for 2 h in order to remove all volatile constituents.

A brown, clear, solid reaction product is obtained with a molecular weight of Mw=18 843 g/mol, Mn=6920 g/mol. By 29Si NMR spectroscopy, the copolymer obtained has the percentage composition (mol %): [(C₆H₅)SiO_{3/2}]_{84.6}[(C₆H₅)(OH)₂SiO_{1/2}]_{3.1}[(CH₃)₂(H)SiO_{1/2}]_{3.5}[(CH₃)₂(C₁₀H₁₃O_{1.5})SiO_{1/2}]_{0.3} [(CH₃)₂(poly-2,6-dimethylphenol)SiO_{1/2}]_{4.8}[(CH₃)₂(CH₂═HC)SiO_{1/2}]6.8, where the 6.8 mol % of [(CH₃)₂(CH₂═HC)SiO_{1/2}]— units must be bonded to the former OH groups since there is no alternative under the reaction conditions chosen.

The residual OH content is still 0.05 percent by weight determined by ¹H NMR spectroscopy.

This copolymer is referred to hereinafter as 1.2.2.

Copolymer 1.2.2. contains more than 30 percent by weight of polyarylene ether units, more than 0.5 mol % of olefinically unsaturated groups, and the proportion of three-dimensionally crosslinked silicone units in the polyorganosiloxane skeleton is more than 40 mol %, especially more than 50 mol %. This means that all criteria for inventiveness are met.

In addition Si—H groups are present, such that curing can be effected either by hydrosilylation or by free radical means.

### Example 2: Production of a Copolymer of the Invention by Oxidative Coupling

### 2.1. Production of a Hydroxyaryl-Functional Three-Dimensionally Crosslinked Polyorganosiloxane:

700 g of a polyorganosiloxane percentage composition (in mol %) [(C₆H₅)SiO_{3/2}]₄₃[(C₆H₅)(OH)₂SiO_{1/2}]_{0.7}[(C₆H₅)(OH)SiO_{2/2}]_{29.3}[(CH₃)₂(H)SiO_{1/2}]_{27.0}, Mw=3419 g/mol, Mn=1741 g/mol is dissolved in 500 g of toluene. 120 g (=0.73 mol) of 4-allyl-2-methoxyphenol (eugenol, C₁₀H₁₂O₂, 164.2 g/mol) and 100 g (=0.82 mol) of allyl methacrylate (C₇H₁₀O₂, 126.16 g/mol) is added to this solution at room temperature of 23° C., and the mixture is homogenized by stirring with a laboratory paddle stirrer. The solution is heated up to internal temperature 80° C., and the heating output in the heating device is adjusted such that this temperature is kept constant. At this temperature. 0.69 g of a 4% platinum(IV)-containing solution of hexachloroplatinic acid in propanediol is added, meaning that 30 ppm of platinum(IV) is available for the catalysis, based on the amount of coreactants of 920 g. The further procedure is as in example 1.1., and the result is as follows:
²⁹Si NMR the percentage composition (in mol %) [(C₆H₅)SiO_{3/2}]_{44.9}[(C₆H₅)(OH)₂SiO_{1/2}]_{0.7}[(C₆H₅)(OH)SiO_{2/2}]_{27.4}[(CH₃)₂(H)SiO_{1/2}]_{11.6}[(CH₃)₂SiO_{2/2}]_{1.0}[(CH₃)₂(C₁₀H₁₃O₂)SiO_{1/2}]_{6.5}[(CH₃)₂(C₇H₁₁O₂)SiO_{1/2}]_{7.9},
where the formation of the [(CH₃)₂SiO_{2/2}]— units can most likely be explained by loss of hydrogen during the reaction and formation of siloxane bonds.

By SEC, the molecular weight is Mw=4369 g/mol and Mn=2018 g/mol. The number of hydroxyaryl-functional radicals based on all Si-bonded radicals is 3.6 mol %. The number of olefinically unsaturated groups is 4.3 mol %.

2.2. Oxidative Coupling of the Polyorganosiloxane from 2.1. With Phenols:

The procedure corresponds to that described in 1.2. 187 g of brown, clear product which is solid at room temperature is obtained, which can be dissolved easily both in toluene and xylene in a concentration of 50% by weight to give a brown, clear solution of low viscosity. By ²⁹Si NMR spectroscopy, the copolymer obtained has the percentage composition (mol %): [(C₆H₅)SiO_{3/2}]_{50.2}[(C₆H₅)(OH)₂SiO_{1/2}]_{0.5}[(C₆H₅)(OH)SiO_{2/2}]_{22.4}[(CH₃)₂(H)SiO_{1/2}]_{11.2}[(CH₃)₂SiO_{2/2}]_{1.4}[(CH₃)₂(C₁₀H₁₃O₂)SiO_{1/2}]_{0.6}[(CH₃)₂(poly-2,6-dimethylphenol)SiO_{1/2}]_{5.9}[(CH₃)₂(C₇H₁₁O₂)SiO_{1/2}]_{7.8}.

The molecular weight is determined as Mw=12 334 g/mol, Mn=4987 g/mol. The proportion of poly-2,6-dimethylphenol units in the polyorganosiloxane-polyphenylene ether copolymer by ¹H NMR is 63% by weight. The proportion of OH groups in the copolymer (phenolic OH groups and silanol groups together) is 0.8% by weight.

This copolymer is referred to hereinafter as 2.2.

It contains more than 30 percent by weight of polyarylene ether units, more than 0.5 mol % of olefinically unsaturated groups, and the proportion of three-dimensionally crosslinked silicone units in the polyorganosiloxane skeleton is more than 40 mol %, especially more than 50 mol %. This means that all criteria for inventiveness are met.

In addition, Si—1 groups are present, and so curing can be effected both by hydrosilylation or by free-radical means.

### Example 3: Production of a Copolymer of the Invention by Oxidative Coupling (Methyl Resin without Excess Si—H)

### 3.1. Production of a Hydroxyaryl-Functional, Three-Dimensionally Crosslinked Polyorganosiloxane:

700 g of a polyorganosiloxane of percentage composition (in mol %) [(CH₃)SiO_{3/2}]₅₆[(CH₃)(OH)₂SiO_{1/2}]_{1.7}[(CH₃)(OH)SiO_{2/2}]_{28.3}[(CH₃)₂(H)SiO_{1/2}]₁₄, Mw=3965 g/mol, Mn=1984 g/mol is dissolved in 500 g of toluene. 120 g (=0.73 mol) of 4-allyl-2-methoxyphenol (eugenol, C₁₀H₁₂O₂, 164.2 g/mol) and 100 g (=0.82 mol) of allyl methacrylate (C₇H₁₀O₂ 126.16 g/mol) are added to that solution at room temperature of 23° C., and the solution is homogenized by stirring with a laboratory paddle stirrer. The further procedure is as described in example 2, and the following result is obtained: by ²⁹Si NMR as percentage composition (in mol %): [(CH₃)SiO_{3/2}]_{61.2}[(CH₃)(OH)₂SiO_{1/2}]_{1.2}[(CH₃)(OH)SiO_{2/2}]_{23.6}[(CH₃)₂(CH₁₀H₁₃O₂)SiO_{1/2}]_{6.3}[(CH₃)₂(C₇H₁₁O₂)SiO_{1/2}]_{7.7}, and by SEC a molecular weight of Mw=4259 g/mol and Mn=2028 g/mol. The number of hydroxyaryl-functional radicals based on all Si-bonded radicals is 4.1 mol %. The number of olefinically unsaturated groups is 5.0 mol %.

3.2. Oxidative Coupling of the Polyorganosiloxane from 3.1. With Phenols:

The procedure corresponds to that described in 1.2. 178 g of brown, clear product which is solid at room temperature is obtained, which can be dissolved easily both in toluene and xylene in a concentration of 50% by weight to give a brown, clear solution of low viscosity. By ²⁹Si NMR spectroscopy, the copolymer obtained has the percentage composition (mol %): [(CH₃)SiO_{3/2}]_{63.7}[(CH₃)(OH)₂SiO_{1/2}]_{0.7}[(CH₃)(OH)SiO_{2/2}]_{21.6}[(CH₃)₂(C₁₀H₁₃O₂)SiO_{1/2}]_{0.3}[(CH₃)₂(poly-2,6-dimethylphenol)SiO_{1/2}]_{5.9}[(CH₃)₂(C₇H₁₁O₂)SiO_{1/2}]_{7.8}.

The molecular weight is determined as Mw=13 394 g/mol. Mn=5094 g/mol. The proportion of poly-2,6-dimethylphenol units in the polyorganosiloxane-polyphenylene ether copolymer by ¹H NMR is 60% by weight.

This copolymer is referred to hereinafter as 3.2.

It contains more than 30 percent by weight of polyarylene ether units, more than 0.5 mol % of olefinically unsaturated groups, and the proportion of three-dimensionally crosslinked silicone units in the polyorganosiloxane skeleton is more than 40 mol %, especially more than 50 mol %. This means that all criteria for inventiveness are met.

Since there are no Si—H groups, curing can proceed only by free-radical means.

### Example 4: Inventive Copolymer with Functionalization by Chloropropionyl Chloride

Copolymer 1.2.1. is worked up further as follows:

A 50% by weight solution of copolymer 1.2.1. is prepared by dissolving 1(0) g of that copolymer (5.8 mmol) in 100 g of toluene.

34.4 g (0.27 mol) of 3-chloropropionyl chloride (126.97 g/mol) is metered in and the mixture is stirred at 80° C. for 2 h. This is followed by cooling to 50° C. and metered addition of 33.5 g (0.33 mol) of triethylamine (101.19 g/mol). After metered addition has ended, stirring is continued at 50° C. for 60 minutes in order to complete the reaction.

Aqueous workup is conducted analogously to example 1.

A brown, clear solid reaction product is obtained with a molecular weight of Mw=19 438 g/mol, Mn=7020 g/mol. By 29Si NMR spectroscopy, the copolymer obtained has the percentage composition (mol %): [(C₆₁H₅)SiO_{3/2}]_{90.8}[(CH₃)₂(H)SiO_{1/2}]_{1.2}[(CH₃)₂SiO_{2/2}]2.2[(CH₃)₂(C₁₃H₁₆O₄)SiO_{1/2}]_{0.4}[(CH₃)₂(poly-2,6-dimethylphenol-O(O═)C—CH═CH₂)SiO_{1/2}]_{5.4}.

The radical (poly-2,6-dimethylphenol-O(O═)C—CH═CH₂) means a polyarylene ether radical which is bonded to the polyorganosiloxane skeleton via the eugenol group and which has been acrylate-functionalized on the terminal phenol 01-1 group by reaction with the 3-chloropropionyl chloride.

The radical (C₁₃H₁₆O₄) means an acrylate-functionalized eugenol radical.

There are no acrylate radicals bonded to the polyorganosiloxane skeleton under the conditions chosen since the Si-acetyloxy bond is unstable under the hydrolytic workup conditions, is cleaved and forms [(C₆H₅)SiO_{3/2}]— groups that make a contribution to the polyorganosiloxane network. The acrylic acid-amine adducts are removed in the aqueous workup.

In the workup, a portion of the Si—H groups is lost via the elimination of the hydridic hydrogen. This forms the [(CH₃)₂SiO_{2/2}]— groups.

This copolymer is referred to hereinafter as 4.1.

### Example 5: Inventive Copolymer Produced from Bisphenol a and Phenol

The polyorganosiloxane according to example 2.1. is subjected to oxidative coupling as follows:

The procedure corresponds to that described in example 2.2., except that 122 g (1 mol) of 2,6-xylenol (122.2 g/mol) and 18 g (0.06 mol) of 2,2′-diallylbisphenol A (308.41 g/mol) were dissolved in 200 ml of toluene and metered in.

A copolymer of the following percentage composition is obtained (mol % by 29Si NMR): [(C₆H₅)SiO_{3/2}]_{51.9}[(C₆H₅)(OH)SiO_{2/2}]_{21.2}[(CH₃)₂(H)SiO_{1/2}]_{10.9}[(CH₃)₂SiO_{2/2}]_{1.7}[(CH₃)₂(C₁₀H₁₃O₂)SiO_{1/2}]_{0.3}[(CH₃)₂(poly-2,6-dimethylphenol-diallylbisphenol A copolymer)SiO_{1/2}]_{6.2}[(CH₃)₂(C₇H₁₁O₂)SiO_{1/2}]_{7.8}.

The molecular weight is determined as Mw=18 443 g/mol, Mn=6198 g/mol.

This copolymer is referred to hereinafter as 5.1.

### Example 6: Use of a Bridged Siloxane Unit

### 6.1. Production of a Hydroxyaryl-Functional Polyorganosiloxane

The polyorganosiloxane [(CH₃)SiO_{3/2}]_{13.1}[(CH₃)(OH)SiO_{2/2}]_{0.9}[(CH₃)O_{2/2}Si—CH₂—CH₂—Si(CH₃)O_{2/2}]_{61.7}[(CH₃)₂(H)SiO_{1/2}]_{24.3}, Mw=1569 g/mol, Mn=948 g/mol is used, analogously to the procedure for example 2.1., to produce a methacrylate- and hydroxyaryl-functional polyorganosiloxane, except that, by contrast with example 2.1., rather than eugenol, 2,6-dimethyl-4-allylphenol (=4-allyl-2,6-xylenol, C₁₁H₁₄O₂, Mw=162.2 g/mol) is used in an amount of 178 g (=1.1 mol), with the following result:

By ²⁹Si NMR, a hydroxyaryl-functional polyorganosiloxane is obtained with the following percentage composition (mol %): [(CH₃)SiO_{3/2}]₁₃[(CH₃)(OH)SiO_{2/2}]I₁[(CH₃)O_{2/2}Si—CH₂—CH₂—Si(CH₃)_{2/2}]_{61.6}[(CH₃)₂(H)SiO_{1/2}]_{0.1}[(CH₃)₂(C₁₁H₁₅O₂)SiO_{1/2}]_{13.1}[(CH₃)₂(C₇H₁₁O₂)SiO_{1/2}]_{11.2}, Mw=2304 g/mol, Mn=1399 g/mol. This polyorganosiloxane is referred to hereinafter as 6.1.

### 6.2. Production of an Inventive Copolymer of the Formula (I) by Oxidative Coupling

Analogously to the procedure as described in example 2.2., 6.1. is used to produce, by oxidative coupling, an inventive polyarylene ether-polysiloxane copolymer. The end product, referred to hereinafter as 6.2., has the following percentage composition (mol % by ²⁹Si NMR):
[(CH₃)SiO_{3/2}]_{13.3}[(CH₃)(OH)SiO_{2/2}]I_{0.7}[(CH₃)O_{2/2}Si—CH₂—CH₂—Si(CH₃)O_{2/2}]_{61.6}[(CH₃)₂(H)SiO_{1/2}]_{0.1}[(CH₃)₂(C₁₁H₁₅O₂)SiO_{1/2}]_{0.7}[(CH₃)₂(poly-2,6-dimethylphenol)SiO_{1/2}]_{12.5}[(CH₃)₂(C₇H₁₁O₂)SiO_{1/2}]_{11.1}, Mw=24 678 g/mol, Mn=8893 g/mol. This polyorganosiloxane is referred to hereinafter as 6.2.

### Example 7: Comparative Example: Oil Copolymer from Prior Art U.S. Pat. No. 8,017,697

Example 1 from U.S. Pat. No. 8,017,697 was reworked as described therein. The required eugenol-terminated polydimethylsiloxane with chain length 45, by contrast with U.S. Pat. No. 8,017,697, was not sourced from Momentive Performance Materials but produced by the hydrosilylation method for eugenol in example 1 from U.S. Pat. No. 5,357,022. The identity of the product, especially the correctness of the chain length of the polydimethylsiloxane and the success of the hydrosilylation reaction, was confirmed by ²⁹Si NMR spectroscopy.

The reaction conditions and the relative amounts of the raw materials used were adjusted according to table 2 in U.S. Pat. No. 8,017,697.

The following properties were determined for the copolymer obtained:
Mw=49 900 g/mol, Mn=18 500 g/mol, Mw/Mn=2.7
Proportion by weight of dimethylsiloxane in the copolymer: 5.0%

No hints of siloxane not incorporated into the copolymer were found, and so a siloxane incorporation efficiency of close to 100% may be assumed. With this result, the reworking of example 1 according to U.S. Pat. No. 8,017,697 can be considered to have been successful, and the product obtained corresponds to the invention according to U.S. Pat. No. 8,017,697. It contains neither olefinically unsaturated groups nor network-forming siloxane constituents, as in accordance with the prior art. This copolymer is referred to hereinafter as 7.1.

### Example 8: Use of the Inventive and Noninventive Organopolysiloxanes According to Examples 1-7 for Production of Metal-Clad Laminates

The inventive and noninventive polyorganosiloxanes obtained according to synthesis examples 1 to 7 were used as binders in order to produce copper-clad laminates with a glass fiber-reinforced composite layer. The following feedstocks were used:
Copper foil: 35 μm-thick copper foil (285±10 g/m²) from Jiangtong-yates Copper Foil Co Ltd, with a ten-point mean roughness of Rz≤8 μm and an arithmetic mean roughness of Ra≤0.4 μm, purity ≥99.8%.

Glass fibers: E glass fibers, Type 1080 E, produced by Changzhou Xingao Insulation Materials Co. Ltd. Thickness 0.055±0.012 mm, 47.5±2.5 g/m².

All organopolysiloxane-polyarylene ether copolymers were used as a solution in xylene. The solutions each contained 35 percent by weight of copolymer and initiator, and 65 percent by weight of xylene.

In order to initiate the curing of the olefinically unsaturated copolymers 1.2.2., 2.2., 3.2., 4.1., 5.1. and 6.2., the organopolysiloxanes were admixed with 1 percent by weight in each case of dicumyl peroxide based on the amount of polyorganosiloxane used, which was distributed homogeneously in the resin matrix by stirring. Noninventive copolymer 7.1. was treated analogously once for comparative purposes, even though it is chemically impossible in this way to achieve curing and crosslinking thereof. In addition, 7.1. was used to produce a chemically curable binder formulation by producing a chemically curable mixture in accordance with the instructions from example 1 in EP0592145. The percentages by weight that follow here are based on 100% of the finished formulation.

In accordance with example 1 of EP0592145, 21.7 percent by weight of 7.1. was dissolved in 65.1 percent by weight of toluene and mixed with 8.9 percent by weight of EPON 828 (Hexion Inc.), 3.3 percent by weight of N,N′-1,3-phenylenebismaleimide and 1.1 percent by weight of aluminum triacetylacetonate (=Al(acac)₃), observing the temperatures and sequence as specified in example 1 in EP0592145.

The laminates for testing were produced from the mixture obtained as further specified hereinafter.

Laminates of 1.2.2., 2.2., 3.2., 4.1., 5.1. and 6.2. were produced by impregnating 30×30 cm glass fiber layers layer by layer in bubble-free form with the respective copolymer in the form of a xylenic solution using an air bleed roller. The procedure with 7.1. was effected analogously in the same way, except using the solution produced specially for the purpose according to the prior art, as described further above in this example. In order to ensure comparability, copolymers 1.2.2., 2.2., 3.2., 4.1., 5.1. and 6.2. as a xylenic solution as specified above were likewise adjusted to about 35 percent by weight of solids, including the initiator.

The glass fiber layers were placed here on a dimensionally stable flat stainless steel base, to which a layer of copper foil had been applied before the first layer of glass fibers was placed on top. A total of 3 layers of glass fiber weave was impregnated successively. In order to remove the solvent if necessary, the impregnated weave was dried to constant weight at 60° C. in a vacuum drying cabinet at 10 mbar. Thereafter, a second layer of copper foil was applied to the top of the impregnated glass fiber layer, and a further dimensionally stable stainless steel plate was placed on top. The laminate was baked in a heatable press at pressure 2 MPa for 120 min at 200° C. and a reduced pressure of 30 mbar. This affords copper-clad laminates having a total thickness of 260 t 20 μm.

Dielectric properties were determined in accordance with IPC TM 650 2.5.5.13 with a Keysight/Agilent E8361A network analyzer by the split cylinder resonator method at 10 GHz. The following values were obtained:

| Organopolysiloxane | Dₖ | D_{f} |
|---|---|---|
| 1.2.2. (inventive) | 2.78 | 0.0020 |
| 2.2. (inventive) | 2.89 | 0.0023 |
| 3.2. (inventive) | 3.20 | 0.0021 |
| 4.1. (inventive) | 2.77 | 0.0025 |
| 5.1. (inventive) | 3.34 | 0.0020 |
| 6.2. (inventive) | 2.79 | 0.0021 |
| 7.1. (noninventive) | 3.36 | 0.011 |

The D_{f} values and the Dₖ values of the copper-clad laminates made from the copolymers of the invention are much lower than the D_{f} values and Dₖ values that were achieved with the copolymer from the procedure according to the prior art. Since minimum dielectric loss factors and dielectric constants are the aim for high-frequency applications, the effect of the invention is clearly apparent.

1-10. (canceled)

11. A polyarylene ether-polysiloxane copolymer, comprising:
wherein the polyarylene ether-polysiloxane copolymer contains olefinically unsaturated groups, of the formula (I)
[O_{3-a/2}RₐSi—Y¹(SiRₐO_{3-a/2})_{b}]_{c}(R¹SiO_{3/2})d(R²₂SiO_{2/2})ₑ(R³₃SiO_{1/2})(SiO_{4/2})_{g} (I);
wherein Y¹ is a chemical bond or a di- to dodecavalent organic unsubstituted or heteroatom-substituted aliphatic, cycloaliphatic or aromatic, organic radical bonded to the silicon atoms via a Si bond and having 1 to 24 carbon atoms;
wherein R, R¹, R² and R³ are independently the same or different and are either a hydrogen radical, a hydroxy radical or a Si—C-bonded or Si—O-bonded, monovalent, unsubstituted or heteroatom-substituted and optionally organofunctional organic hydrocarbyl radical having 1 to 18 carbon atoms or a Si—C-bonded polyarylene ether radical;
wherein the proportion of the hydroxyl radicals and of the Si—O-bonded radicals based on the sum total of all R, R¹, R² and R³ radicals as 100 percent by weight is not more than 5 percent by weight;
wherein the proportion of the Si—C-bonded polyarylene ether radicals based on the sum total of all R, R¹, R² and R³ radicals as 100 percent by weight is at least 10 percent by weight;
wherein the proportion of the olefinically or acetylenically unsaturated radicals based on all R, R¹, R² and R³ radicals as 100 mol % is at least 0.5 mol %;
wherein the polyarylene ether radical is selected from a radical of the formula (II) or (III) 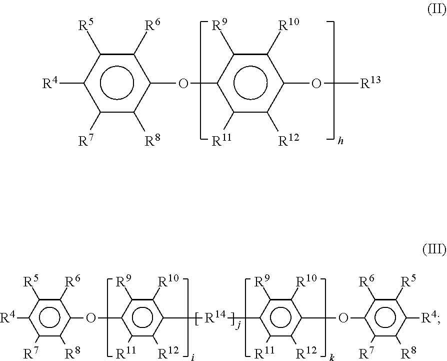
wherein R⁴, R⁵, R⁶, R⁷, R⁸, R⁹, R¹⁰, R¹¹, R¹² and R¹³ are independently a hydrogen radical, a monovalent hydrocarbyl group, a heteroatom-substituted hydrocarbyl group, an organofunctional radical or a silyl group of the (R⁴⁰₃Si—) form where R⁴⁰ has the definitions of R³ and the R⁴ to R¹² radicals may also be bonded to the aromatic ring via a heteroatom;
wherein the R⁴, R⁵ and R⁶ radicals may also be a chemical bond or a divalent aliphatic, cycloaliphatic or aromatic hydrocarbyl radical having 1 to 12 carbon atoms, by which the bond of the radicals of the formula (II) to the polyorganosiloxane skeleton is established, where at least one R⁴, R⁵ or R⁶ radical is a radical that establishes a bond to the polyorganosiloxane skeleton;
wherein, as far as chemically possible, adjacent radicals from the group of the R⁴ to R¹² radicals may also be joined to one another to form the same cyclic saturated or unsaturated radical, so as to form fused polycyclic structures that include both cycloaliphatic and cycloaromatic structures or mixed forms thereof;
wherein R¹⁴ is a chemical bond or a divalent, optionally substituted arylene radical of the (—C₆R¹⁵₄—) form where R¹⁵, independently of these, may have the same meaning as the R⁹, R¹⁰, R¹¹ or R¹² radicals or is an alkylene radical of the —CR¹⁶₂-form where R¹⁶, independently of R¹⁵, may have the same meanings as R¹⁵, a divalent glycol radical of the —[(OCH₂)₂O]ₗ— or —[(OCH₂CH(CH₃)₂)O]ₘ— form where l and m are each independently integers each having a value from 1 to 50 inclusive, a divalent silyloxy radical of the —Si(R¹⁷)₂O_{2/2}— form, a divalent siloxane radical of the —[(CH₂)₃Si—[O—Si(R¹⁸)₂]ₙO—Si(CH₂)₃— form, a divalent silyl radical of the —Si(R¹⁹)₂— form, where R¹⁷, R¹⁸ and R¹⁹, independently of one another and independently of R¹⁵, may have the same meanings as R¹⁵ and n is an integer having a value in each case of 0 to 500 inclusive;
wherein
a is an integer having a value of 0, 1 or 2, where the indices a on either side of the Y group may assume their meaning independently of one another, such that different a may independently have different values within the range of values specified,
h has a value from 0 to 1000,
b is an integer having a value from 1 to 11,
c has a value from 0 to 0.9,
d has a value from 0 to 1,
e has a value from 0 to 0.5,
f has a value from 0 to 0.6,
g has a value from 0 to 0.2,
i is an integer having a value of in each case 0 to 50 inclusive,
j is an integer having a value of in each case 0 to 10 inclusive, and
k is an integer having a value of in each case 0 to 50 inclusive;
wherein c+d+e+f+g=1 and at least c or d has a value other than 0 and the sum of c+d accounts for a proportion of at least 40% of the sum of c+d+e+f+g; and
wherein at least one polyarylene ether radical of the formula (II) or (III) is present in each polyarylene ether-polysiloxane copolymer of the formula (I).

12. The copolymer of claim 11, wherein the unsubstituted R, R¹, R², R³ radicals are selected from methyl, ethyl and n-propyl radical and phenyl radical.

13. The copolymer of claim 11, wherein the olefinically or acetylenically unsaturated R, R¹, R² and R³ radicals are selected from acrylate, methyl acrylate, methyl methacrylate, n-butyl acrylate, iso-butyl acrylate, t-butyl acrylate, 2-ethylhexyl acrylate, and norbornyl acrylate, vinyl, allyl, propenyl, butenyl, 1,3-butadienyl and isoprenyl radical.

14. The copolymer of claim 11, wherein the proportion of the Si—C-bonded polyarylene ether radicals based on the sum total of all R, R¹, R² and R³ radicals as 100 percent by weight is at least 30 percent by weight.

15. The copolymer of claim 11, wherein the polyarylene ether-polysiloxane copolymer is solid at 25° C. and has a glass transition temperature of 25° C. to 350° C.

16. The copolymer of claim 11, wherein the polyarylene ether-polysiloxane copolymer has no units of the formula (R²₂SiO_{2/2})ₑ.

17. The copolymer of claim 11, wherein the polyarylene ether-polysiloxane copolymer is used in the production of coating materials and impregnations and coatings and coverings to be produced therefrom on substrates, as binder or as additive in formulations.

18. The copolymer of claim 11, wherein the polyarylene ether-polysiloxane copolymer is used for the production of metal foil-clad laminates.

19. The copolymer of claim 18, wherein the metal foil-clad laminates is selected from copper, stainless steel, gold, aluminum, silver, zinc, tin, lead and transition metals.

20. A process for preparing polyorganosiloxane-polyarylene ether copolymers, comprising:
providing a polyarylene ether-polysiloxane copolymer containing olefinically unsaturated groups, of the formula (I)
[O_{3-a/2}RₐSi—Y¹(SiRₐO_{3-a/2})_{b}]_{c}(R¹SiO_{3/2})_{d}(R²₂SiO_{2/2})ₑ(R³₃SiO_{1/2})_{f}(SiO_{4/2})_{g} (I),
wherein Y¹ is a chemical bond or a di- to dodecavalent organic unsubstituted or heteroatom-substituted aliphatic, cycloaliphatic or aromatic, organic radical bonded to the silicon atoms via a Si bond and having 1 to 24 carbon atoms,
wherein R, R¹, R² and R³ are independently the same or different and are either a hydrogen radical, a hydroxy radical or a Si—C-bonded or Si—O-bonded, monovalent, unsubstituted or heteroatom-substituted and optionally organofunctional organic hydrocarbyl radical having 1 to 18 carbon atoms or a Si—C-bonded polyarylene ether radical,
wherein the proportion of the hydroxyl radicals and of the Si—O-bonded radicals based on the sum total of all R, R¹, R² and R³ radicals as 100 percent by weight is not more than 5 percent by weight,
wherein the proportion of the Si—C-bonded polyarylene ether radicals based on the sum total of all R, R¹, R² and R³ radicals as 100 percent by weight is at least 10 percent by weight,
wherein the proportion of the olefinically or acetylenically unsaturated radicals based on all R, R¹, R² and R³ radicals as 100 mol % is at least 0.5 mol %,
wherein the polyarylene ether radical is selected from a radical of the formula (II) or (III) 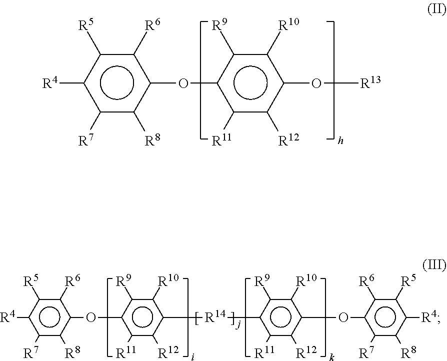
wherein R⁴, R⁵, R⁶, R⁷, R⁸, R⁹, R¹⁰, R¹¹, R¹² and R¹³ are independently a hydrogen radical, a monovalent hydrocarbyl group, a heteroatom-substituted hydrocarbyl group, an organofunctional radical or a silyl group of the (R⁴⁰₃Si—) form where R⁴⁰ has the definitions of R³ and the R⁴ to R¹² radicals may also be bonded to the aromatic ring via a heteroatom,
wherein the R⁴, R⁵ and R⁶ radicals may also be a chemical bond or a divalent aliphatic, cycloaliphatic or aromatic hydrocarbyl radical having 1 to 12 carbon atoms, by which the bond of the radicals of the formula (II) to the polyorganosiloxane skeleton is established, where at least one R⁴, R⁵ or R⁶ radical is a radical that establishes a bond to the polyorganosiloxane skeleton,
wherein, as far as chemically possible, adjacent radicals from the group of the R⁴ to R¹² radicals may also be joined to one another to form the same cyclic saturated or unsaturated radical, so as to form fused polycyclic structures that include both cycloaliphatic and cycloaromatic structures or mixed forms thereof,
wherein R¹⁴ is a chemical bond or a divalent, optionally substituted arylene radical of the (—C₆R¹⁵₄—) form where R¹⁵, independently of these, may have the same meaning as the R⁹, R¹⁰, R¹¹ or R¹² radicals or is an alkylene radical of the —CR¹⁶₂-form where R¹⁶, independently of R¹⁵, may have the same meanings as R¹⁵, a divalent glycol radical of the —[(OCH₂)₂O]ₗ— or —[(OCH₂CH(CH₃)₂)O]ₘ— form where 1 and m are each independently integers each having a value from 1 to 50 inclusive, a divalent silyloxy radical of the —Si(R¹⁷)₂O_{2/2}— form, a divalent siloxane radical of the —[(CH₂)₃Si—[O—Si(R¹⁸)₂]ₙO—Si(CH₂)₃— form, a divalent silyl radical of the —Si(R¹⁹)₂— form, where R¹⁷, R¹⁸ and R¹⁹, independently of one another and independently of R¹⁵, may have the same meanings as R¹⁵ and n is an integer having a value in each case of 0 to 500 inclusive,
wherein
a is an integer having a value of 0, 1 or 2, where the indices a on either side of the Y group may assume their meaning independently of one another, such that different a may independently have different values within the range of values specified,
h has a value from 0 to 1000,
b is an integer having a value from 1 to 11,
c has a value from 0 to 0.9,
d has a value from 0 to 1,
e has a value from 0 to 0.5,
f has a value from 0 to 0.6,
g has a value from 0 to 0.2,
i is an integer having a value of in each case 0 to 50 inclusive,
j is an integer having a value of in each case 0 to 10 inclusive, and
k is an integer having a value of in each case 0 to 50 inclusive,
wherein c+d+e+f+g=1 and at least c or d has a value other than 0 and the sum of c+d accounts for a proportion of at least 40% of the sum of c+d+e+f+g, and
wherein at least one polyarylene ether radical of the formula (II) or (III) is present in each polyarylene ether-polysiloxane copolymer of the formula (I);
oxidatively coupling the arylhydroxy radicals of the polyorganosiloxane compounds of the formula (VII)
[O_{3-a/2}R³¹ₐSi—Y¹(SiR³¹ₐO_{3-a/2})_{b}]_{c}(R³²SiO_{3/2})_{d}(R³³₂SiO_{2/2})ₑ(R³⁴₃SiO_{1/2})_{f}(SiO_{4/2})_{g} (VII)
wherein R³¹ is an R radical,
wherein R³² is an R¹ radical,
wherein R³³ is an R² radical,
wherein R³⁴ is an R³ radical and Y² is a Y¹ radical, with the difference that, if R³¹, R³², R³³ or R³⁴ is a radical of the formula (II) or if Y² comprises such a radical of the formula (II), the index h in this radical of the formula (II) is always 0 and the R¹³ radical is always a hydrogen radical and that R³¹, R³², R³³ and R³⁴ cannot be a polyarylene ether radical of the formula (III), and that Y² cannot contain a radical of the formula (III),
wherein at least 1 mol % of all Si-bonded radicals are a radical of the formula (II) with h=0 and R¹³=hydrogen,
wherein phenols of the formula (VIIIa) or (VIIIb) or a mixture of (VIIIa) and (VIIIb) 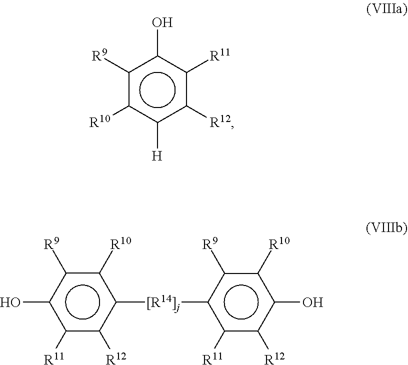
wherein the R⁹, R¹⁰, R¹¹, R¹² and R¹⁴ radicals and j have the definitions given in the preceding claims.

21. The process of claim 20, wherein the unsubstituted R, R¹, R², R³ radicals are selected from methyl, ethyl and n-propyl radical and phenyl radical.

22. The process of claim 20, wherein the olefinically or acetylenically unsaturated R, R¹, R² and R³ radicals are selected from acrylate, methyl acrylate, methyl methacrylate, n-butyl acrylate, iso-butyl acrylate, t-butyl acrylate, 2-ethylhexyl acrylate, and norbornyl acrylate, vinyl, allyl, propenyl, butenyl, 1,3-butadienyl and isoprenyl radical.

23. The process of claim 20, wherein the proportion of the Si—C-bonded polyarylene ether radicals based on the sum total of all R, R¹, R² and R³ radicals as 100 percent by weight is at least 30 percent by weight.

24. The process of claim 20, wherein the polyarylene ether-polysiloxane copolymer has no units of the formula (R²²SiO_{2/2})ₑ.
